(19) United States
(12) Patent Application Publication
(10) Pub. No.: US 2023/0103821 A1
(43) Pub. Date: Apr. 6, 2023

(54) MULTI-MODE ROBOTIC END EFFECTOR

(71) Applicant: Dexterity, Inc., Redwood City, CA (US)

(72) Inventors: Andrew Lovett, Burlingame, CA (US); Alberto Leyva Arvayo, Palo Alto, CA (US); Shitij Kumar, Redwood City, CA (US); Cyril Nader, Palo Alto, CA (US); Cuthbert Sun, San Francisco, CA (US); Anmol Saiprasad Modur, Redwood City, CA (US); Justin Sunjoon Kim, Cupertino, CA (US); Varun Uday Nayak, Palo Alto, CA (US); Samir Menon, Atherton, CA (US)

(21) Appl. No.: 17/960,539

(22) Filed: Oct. 5, 2022

Related U.S. Application Data
(60) Provisional application No. 63/253,045, filed on Oct. 6, 2021.

(51) Int. Cl. B25J 15/00; B25J 15/06

(52) U.S. Cl. CPC B25J 15/0066; B25J 15/0616; B25J 15/0028

(57) ABSTRACT

An end effector is disclosed. The end effector includes a first grasping mechanism for grasping at least one first object when the robotic end effector is operated in a first mode and a second grasping mechanism for grasping a second object when the robotic end effector is operated in a second mode. The second grasping mechanism is robotically positioned in an inactive state when the robotic end effector is controlled to operate in the first mode.

### CROSS REFERENCE TO OTHER APPLICATIONS

This application claims priority to U.S. Provisional Patent Application No. 63/253,045 entitled MULTI-MODE ROBOTIC END EFFECTOR filed Oct. 6, 2021 which is incorporated herein by reference for all purposes.

### BACKGROUND OF THE INVENTION

In certain warehouse and similar operations, a set of tasks sometimes referred to herein as “line kitting” may be performed to assemble stacked trays of items for further distribution, such as delivery to a retail point of sale. Stacks of trays containing the same type of item may be received, and trays may be drawn from different homogeneous stacks each having trays of items of a corresponding type to assemble a mixed stack of trays, e.g., to be sent to a given destination.

For example, a bakery may bake different types of products and may fill stackable trays each with a corresponding homogeneous type of product, such as a particular type of bread or other baked good. Stacks of trays may be provided by the bakery, e.g., to a distribution center. One stack may include trays holding loaves of sliced white bread, another may have trays holding loaves of whole wheat bread, still another tray holding packages of blueberry cupcakes, etc. Trays may be drawn from the various stacks to assemble a (potentially) mixed stack of trays. For example, a stack of six trays of white bread, three trays of whole wheat, and one tray of blueberry cupcakes may be assembled, e.g., for delivery to a retail store.

While the above example involves trays of different types of baked good, in other line kitting operations stackable trays may hold other products.

In a typical approach, trays are handled by human workers. The trays may include handholds to enable a human worker to grasp and move trays, e.g., by placing the workers hand on or in the handhold. Such work by human workers may cause fatigue or injuries, may take a lot of time to complete, and could be error prone.

### BRIEF DESCRIPTION OF THE DRAWINGS

Various embodiments of the invention are disclosed in the following detailed description and the accompanying drawings.

FIG. 1A is a block diagram illustrating an embodiment of a robotic line kitting system.

FIG. 1B is a block diagram illustrating an embodiment of a robotic line kitting system.

FIG. 2A is a state diagram illustrating an embodiment of an automated process to assemble stacks of trays.

FIG. 2B is a flow diagram illustrating an embodiment of an automated process to assemble stacks of trays.

FIG. 2C is a flow diagram illustrating an embodiment of an automated process to pick and place items to/from a tray.

FIG. 3A is a diagram illustrating an embodiment of a robotically controlled tray handling end effector.

FIG. 3B is a diagram illustrating an embodiment of a robotically controlled tray handling end effector.

FIG. 3C is a diagram illustrating an embodiment of a robotically controlled tray handling end effector.

FIG. 4 is a flow diagram of a process for operating an end effector to move an object according to various embodiments.

FIG. 5A is a flow diagram of a process for operating an end effector in connection with picking or placing an item to/from a tray according to various embodiments.

FIG. 5B is a flow diagram of a process for operating an end effector in connection with picking or placing an item to/from a tray according to various embodiments.

FIG. 6A is a flow diagram of a process for operating an end effector in connection with picking or placing a tray or other receptacle according to various embodiments.

FIG. 6B is a flow diagram of a process for operating an end effector in connection with picking or placing a tray or other receptacle according to various embodiments.

FIG. 6C is a flow diagram of a process for operating an end effector in connection with picking or placing a tray or other receptacle according to various embodiments.

FIG. 6D is a flow diagram of a process for operating an end effector in connection with picking or placing a tray or other receptacle according to various embodiments.

FIG. 7A is a diagram illustrating an end effector configured in a first mode according to various embodiments.

FIG. 7B is a diagram illustrating an end effector configured in a first mode according to various embodiments.

FIG. 7C is a diagram illustrating an end effector configured in a first mode according to various embodiments.

FIG. 8A is a diagram illustrating a robotically controlled tray and item handling end effector according to various embodiments.

FIG. 8B is a diagram illustrating a robotically controlled tray and item handling end effector according to various embodiments.

FIG. 8C is a diagram illustrating a robotically controlled tray and item handling end effector according to various embodiments.

FIG. 9A is a diagram illustrating a robotically controlled tray and item handling end effector according to various embodiments.

FIG. 9B is a diagram illustrating a robotically controlled tray and item handling end effector according to various embodiments.

FIG. 10A is a diagram illustrating a robotically controlled tray and item handling end effector equipped with a guide fin according to various embodiments.

FIG. 10B is a diagram illustrating a robotically controlled tray and item handling end effector equipped with a guide fin according to various embodiments.

FIG. 10C is a diagram illustrating a robotically controlled tray and item handling end effector equipped with a guide fin according to various embodiments.

FIG. 10D is a diagram illustrating a robotically controlled tray and item handling end effector equipped with a guide fin according to various embodiments.

FIG. 11 is a flow diagram of an automated process to place one or more trays on a stack according to various embodiments.

FIG. 12 is a diagram illustrating an example of a stack of trays configured to be stacked in a specific tray orientation.

FIG. 13 is a diagram illustrating an embodiment of a tray handling robot.

FIG. 14 is a flow diagram of a process for selecting a mode according to which an end effector is to be operated, and operating the end effector in a selected mode according to various embodiments.

FIG. 15A is a diagram illustrating a bottom view of a suction-based end effector according to various embodiments.

FIG. 15B is a diagram illustrating a bottom view of a suction-based end effector according to various embodiments.

FIG. 15C is a diagram illustrating a bottom view of a suction-based end effector according to various embodiments.

FIG. 15D is a diagram illustrating a bottom view of a suction-based end effector according to various embodiments.

FIG. 15E is a diagram illustrating a side view of a suction-based end effector according to various embodiments.

FIG. 15F is a diagram illustrating a side view of a suction-based end effector according to various embodiments.

FIG. 16 is a flow diagram of a process for operating an end effector in connection with picking or placing a set of items according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An autonomous, tray handling, line kitting robot is disclosed. In various embodiments, a line kitting robot as disclosed herein includes a robotic arm having an end effector as disclosed herein comprising structures to grasp a tray of items. In various embodiments, one or more such robots may operate together in a single workspace to grasp trays from source stacks and move them, singly or in groups, to destinations stacks assembled according to invoice, manifest, or other input data indicating the output stacks required to be assembled. In some embodiments, two or more robots as disclosed herein may operate on the same rail or other transport structure. Operation is coordinated to avoid collisions and to make efficient use of all robots to complete an overall set of line kitting tasks, such as to assemble a plurality of output stacks each having a corresponding mix of trays according to input information, such as invoices, manifests, etc.

Various embodiments include an end effector device (also referred to herein as an end effector) to be comprised in, or connected to, a robotic arm to grasp, move, and place one or more trays, items within trays or other receptacles, or other objects. The end effector comprises (i) a first grasping mechanism for grasping at least one first object when the robotic end effector is operated in a first mode, (ii) a second grasping mechanism for grasping a second object when the robotic end effector is operated in a second mode. The second grasping mechanism is robotically positioned in an inactive state when the robotic end effector is controlled to operate in the first mode. The second grasping mechanism is robotically positioned in an active state when the end effector is controlled to operate in the second mode.

Various embodiments include a robotic end effector. The robotic end effector includes a robotically actuated second gripper, a robotically actuated first gripper comprising a first element and second element positioned opposite each other on either side of a central vertical axis of the robotic end effector, wherein the robotically actuated second gripper positioned between the first element and the second element, and a robotically actuated retraction-extension mechanism configured to place the robotic end effector in a first mode of operation in which the first gripper is positioned for use or a second mode of operation in which the second gripper is positioned for use.

As used herein, a first grasping mechanism (which may also be referred to herein as a robotically actuated first gripper) may include a suction-based end effector or other grasping mechanism. In some embodiments, the suction-based end effector comprises a plurality of suction cups. The plurality of suction cups may be controlled collectively, or a subset of the plurality of suction cups may be controlled independent of another subset of the plurality of suction cups. In some embodiments, the suction-based end effector is robotically controlled to pick one or more items from, or place one or more items in, a tray or other receptacle within a workspace of a robot.

As used herein, a second grasping mechanism (which may also be referred to herein as a robotically actuated second gripper) may include an end effector comprising a plurality of gripper arms that picks up a tray (or other item or receptacle) by gripping the sides or bottom of the tray. In some embodiments, one or more gripper arms of the second grasping mechanism are movable with respect to a mount to which the end effector is connected to a robotic arm. As an example, the one or more movable gripper arms may be robotically controlled to close a grip on the tray (e.g., in connection with picking up the tray) or to open a grip with respect to the tray (e.g., in connection with releasing the tray at a destination location). For example, the second grasping mechanism may include an active arm and a passive arm, and the active arm may be robotically controlled to adjust the grip/release of a tray.

Various embodiments include a multi-mode end effector that is operable in a plurality of modes. The plurality of modes may include two or more of a first mode, a second mode, and/or a third mode.

In some embodiments, the first mode includes controlling a suction-based end effector comprised in the multi-mode end effector. The multi-mode end effector may be controlled to pick/place items from/to trays or other receptacles, such as in connection with unloading a tray or assembling a kit based on a predefined manifest (e.g., an order being fulfilled). In some embodiments, when the multi-mode end effector is operated in the first mode, a second grasping mechanism (e.g., an end effector comprising gripper arms) may be positioned in an inactive state (e.g., stowed away in a stowed state or a retracted state) such as to expose the suction-based end effector or to enable the suction-based end effector to better grasp items. For example, in response to determining to operate the multi-mode end effector in the first mode, at least part of the second grasping mechanism (e.g., one or more gripper arms) are controlled to transition such part of the second grasping mechanism to an inactive state (e.g., to move the gripper arm to stow the gripper arm in a position that better exposes the suction-based end effector to items to be grasped).

In some embodiments, the second mode includes controlling an end effector comprising a plurality of gripper arms, such end effector being comprised in the multi-mode end effector. The multi-mode end effector may be controlled to pick and place trays or other receptacles, stacking trays in a tray stack or removing an empty tray to expose another tray (e.g., to expose items within the other tray). In some embodiments, when the multi-mode end effector is operated in the second mode, the second grasping mechanism (e.g., an end effector comprising a plurality of gripper arms) may be positioned in an active state (e.g., positioned to a deployed state) such as to enable the end effector comprising a plurality of gripper arms to engage a tray or other receptacle. For example, in the active state, the gripper arms are positioned to provide clearance between a tray engaged by the gripper arms and a suction-based end effector comprised in the multi-mode end effector. In response to determining to operate the multi-mode end effector in the second mode, at least part of the second grasping mechanism (e.g., one or more gripper arms) are controlled to transition such part of the second grasping mechanism from an inactive state to an active state (e.g., to move the gripper arm to deploy the gripper arm in a position that better exposes the gripper arms to engage a tray).

In some embodiments, the third mode includes controlling the multi-mode end effector to use one or more rigid structures attached to the multi-mode end effector to pull or push an object (e.g., an item, a receptacle such as a tray, or a cart such as a cart comprising a stack of trays), etc. Operating the multi-mode end effector according to the third mode enables the robotic arm to adjust a position of an object.

Related art systems for moving receptacles (e.g., trays, totes, containers, etc.) and for moving items comprised within the receptacles use a first grasping mechanism for picking or placing items from/to the receptacles, and a second grasping mechanism for moving receptacles (e.g., an end effector or a conveyor, etc.). The related art systems do not comprise an end effector that includes the first grasping mechanism and the second grasping mechanism (e.g., related art end effectors do not comprise the first grasping mechanism and second grasping mechanism simultaneously deployed on a particular robotic arm. For example, in some related art systems, a second end effector corresponding to the second grasping mechanism is attached to a robotic arm to move the receptacles, and in order to pick/place items from the receptacles the robotic arm is controlled to attach a different end effector (e.g., a first end effector corresponding to the first grasping mechanism) or a different robotic arm already comprising the first end effector. In other words, related art systems decouple the first end effector from a robotic arm to allow a second end effector to be attached to the robotic arm. End effectors according to related art do not comprise a plurality of end effectors or grasping mechanisms and end effectors according to related art do are not multi-modal in which the end effector is operated according to different modes. Accordingly, related art systems or end effectors are inefficient. For example, related art system may use additional robotic arms such that a subset of robotic arms in the system include a first grasping mechanism, and another subset of robotic arms in the system include a second grasping mechanism, and the different subsets of robotic arms are operated together to perform functions enabled by the first grasping mechanism and functions enabled by the second grasping mechanism. As another example, related art systems may require a first grasping mechanism to be detached (e.g., decoupled) from a robotic arm before attaching the second grasping mechanism, such decoupling and coupling of a different end effector introducing latency in performing both functions enabled by the first grasping mechanism and functions enabled by the second grasping mechanism.

In some embodiments, the system includes a control computer(s) to control the multi-mode end effector to autonomously perform operations. The control computer(s) may be further used to control a robotic arm to which the multi-mode end effector such that the control computer(s) collectively control the robotic arm and the multi-mode end effector in connection with performing a set of tasks. Controlling the multi-mode end effector to autonomously perform operations can include using gripper arms (e.g., gripper arms comprised in the second grasping mechanism) to grasp or move trays (or other receptacles or large items), using the gripper arms to push or pull stacks of trays (e.g., a stack of trays disposed on a dolly or other car, using the first grasping mechanism (e.g., a suction-based end effector) to pick and/or place items from/to trays, or to otherwise move smaller items within the workspace, etc.

In some embodiments, the system determines a set of tasks to be performed (e.g., to achieve a higher-level goal such as fulfilling a set of orders) and determines an order in which the set of tasks are to be performed based on a cost function associated with performing the respective tasks within the set of tasks. The system may determine the order in which the set of tasks are to be performed based on a cost associated with transitioning to control the multi-mode end effector between the first mode or the second mode. For example, the system determines the order in which the set of tasks are to be performed based at least in part on a cost associated with transitioning the second grasping mechanism (e.g., an end effector comprising a plurality of gripper arms) between the inactive state and the active state.

In some embodiments, the system obtains from one or more sensors information pertaining to one or more item attributes for an item(s) within the workspace, and information pertaining to a workspace state. The one or more attributes can include an identifier (e.g., a bar code, a serial number, a product number), a shape, a rigidity, a size, a weight, an indication of whether the item is fragile, an indication of whether the item has soft or deformable packaging, etc. The information pertaining to the workspace state can include one or more of a number of trays (or other receptacles, dollies, carts, etc.), a location of the tray(s) within the workspace, an indication of a product or item comprised in the tray, a location of another robotic arm (if any), a location of other objects or humans within the workspace, etc. In response to obtaining the information pertaining to item attribute and workspace state, the system determines a set of M tasks that are to be performed (e.g., to pick and place items in connection with loading or unloading trays, or kitting orders in accordance with an invoice, packing slip, etc.) and determines one or more plans for controlling the robotic arm to pick and place the item(s) corresponding to the set of M tasks. In some embodiments, the system determines an optimal set of next N tasks of the set of M tasks (e.g., N is less than or equal to M) in connection with performing the set of M tasks. For example, the system determines an optimal order in which the set of M tasks are to be performed. The optimal set of N tasks or order of set of M tasks can be determined based on a cost function or otherwise based at least in part on a multi-mode end effector state (e.g., a state of the second grasping mechanism such as whether the gripper arm(s) are deployed or retracted). For example, changing the state of the second grasping mechanism (e.g., between an active state and an inactive state) has certain associated costs such as time, energy, time, etc. Accordingly, the system can determine an optimal order for completing the set of N tasks to minimize the overall cost of performing the set of N tasks or to satisfy a cost criteria (e.g., an overall cost being less than a predefined cost threshold), or to minimize the cost associated with changing the state of the second grasping mechanism while performing the set of N tasks.

In various embodiments, a tray handling robotic system as disclosed herein includes a single rail system occupied by multiple robots coordinating the fulfilment of trays containing packaged food goods, or any other commercial goods or other items. The trays may arrive in stacks of various heights and stacked in various orientations. In some embodiments, the system is divided into two sides: an input side where homogenous stacks come in and an output side that is dedicated to various customers and/or other destinations and is formed by kitting various products from the input side based on an order list, for example.

In some embodiments, multiple robots operate on the same rail or other transport system. For example, two or more robots may operate on the same rail system. Each robot is mounted on a chassis that can be moved along the rail under robotic control, independently of each other robot. The robots are aware of each other and coordinate their motions to optimize order fulfillment. Each robot may use of a single multi-mode end effector designed to grasp trays (e.g., using a second grasping mechanism such as a tray gripper), and to pick or place items from/to trays (e.g., using a first grasping mechanism such as a suction-based end effector). Alternatively, a robot may use a tray gripper that is designed to grasp a plurality of trays at one time. In various embodiments, the gripper is modular and can be adapted to a variety of different trays.

In various embodiments, a robotic system as disclosed herein is configured to pick from stationary stacks of trays (or other receptacles) which sit upon dollies (or other carts). An example of such a robotic system is disclosed in U.S. patent application Ser. No. 16/797,359 filed on Feb. 21, 2020 entitled Robotic Handling of Soft Products in Non-Rigid Packaging, the entire contents of which are incorporated herein by reference for all purposes. Another example of such a robotic system is disclosed in U.S. patent application Ser. No. 17/712,915 filed on Apr. 4, 2022 entitled Robotic Tray Gripper, the entire contents of which are incorporated herein by reference for all purposes. Another example of such a robotic system is disclosed in U.S. patent application Ser. No. 17/219,509 filed on Date entitled Suction-Based End Effector with Mixed Cup Sizes, the entire contents of which are incorporated herein by reference for all purposes.

Although embodiments described herein are provided in the context of a kitting system or picking and placing items from a tray, various embodiments may be implemented in various other contexts such as palletizing systems, singulation systems, etc.

As used herein, depalletization includes picking an item from a pallet, such as from a stack of items on the pallet, moving the item, and placing the item at a destination location such as a conveyance structure. An example palletization/depalletization system and/or process for palletizing/de-palletizing a set of items is further described in U.S. patent application Ser. No. 17/343,609, the entirety of which is hereby incorporated herein for all purposes.

As used herein, singulation of an item includes picking an item from a source pile/flow and placing the item on a conveyance structure (e.g., a segmented conveyor or similar conveyance). Optionally, singulation may include sortation of the various items on the conveyance structure such as via singly placing the items from the source pile/flow into a slot or tray on the conveyor. An example of singulation system and/or process for singulating a set of items is further described in U.S. patent application Ser. No. 17/246,356, the entirety of which is hereby incorporated herein for all purposes.

As used herein, kitting includes the picking of one or more items/objects from corresponding locations and placing the one or more items in a predetermined location in a manner that a set of the one or more items correspond to a kit. An example of a kitting system and/or process for kitting a set of items is further described in U.S. patent application Ser. No. 17/219,503, the entirety of which is hereby incorporated herein for all purposes.

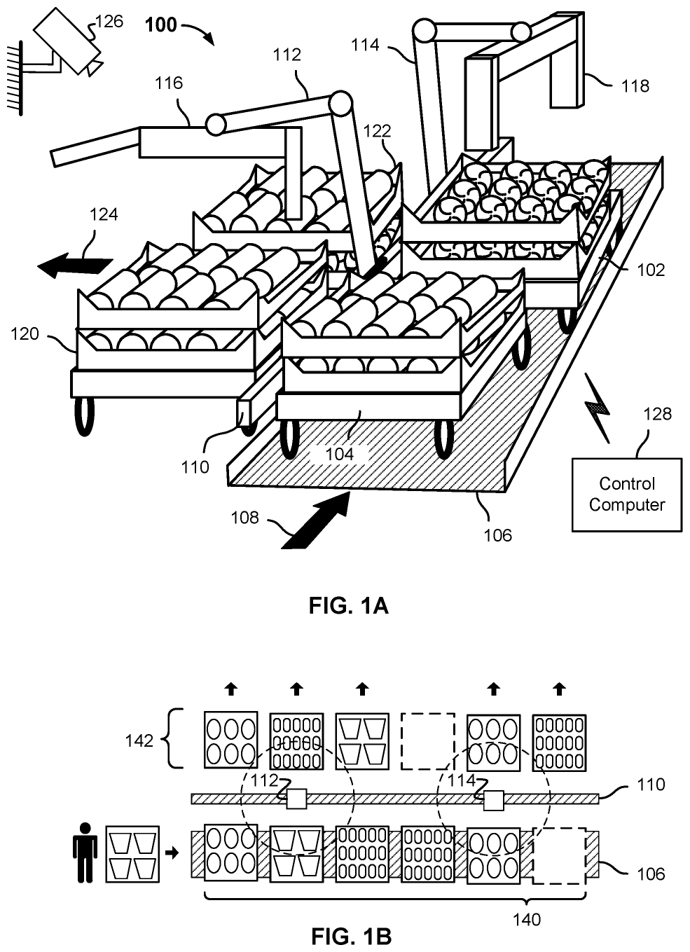

FIG. 1A is a block diagram illustrating an embodiment of a robotic line kitting system. In the example shown, system 100 includes source tray stacks 102 and 104 moving along an input stack conveyance (e.g., conveyance 106) fed in this example from an input end 108 (staging and loading area). Each of the source tray stacks 102 and 104 in this example is shown to be stacked on a wheeled cart or chassis. In various embodiments, the source tray stacks 102 and 104 are pushed manually onto the conveyance 106, which may be a conveyor belt or other structure configured to advance the source tray stacks 102 and 104 through the workspace defined by conveyance 106. In various embodiments, the source tray stacks 102 and 104 may be pushed/pulled onto the conveyance 106 by a robotic arm (e.g., robotic arm 112 or 114), such as a robotic arm being controlled in a third mode in which a multi-mode end effector is used to push/pull a stack of trays. In some embodiments, the chassis or other base structure on which the source trays are stacked is self-propelled. In some embodiments, source tray stacks 102 and 104 is advanced through/by conveyance 106 under robotic control. For example, the speed and times at which the source tray stacks 102 and 104 are advanced by/through conveyance 106 is controlled to facilitate efficient grasping of trays from the source tray stacks 102 and 104.

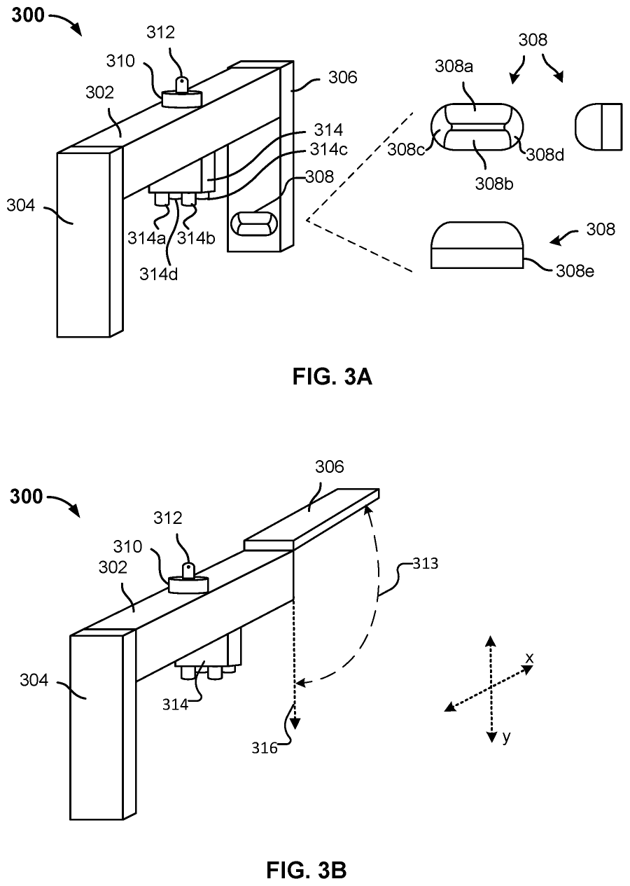

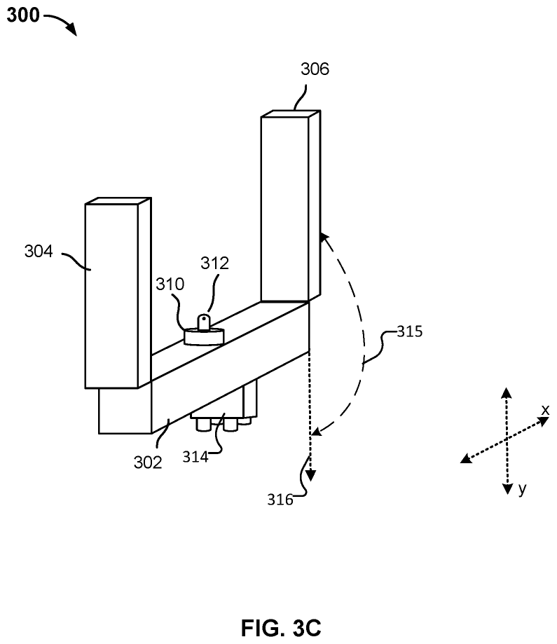

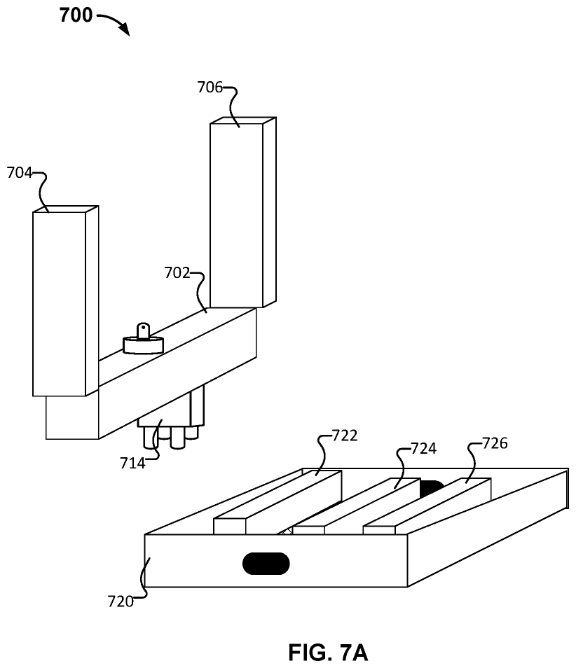

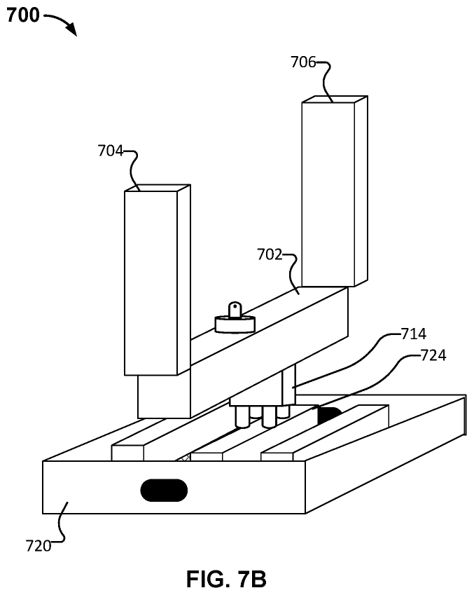

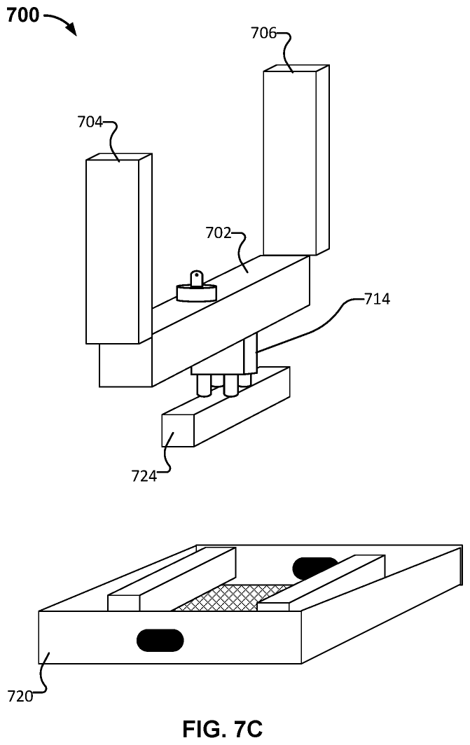

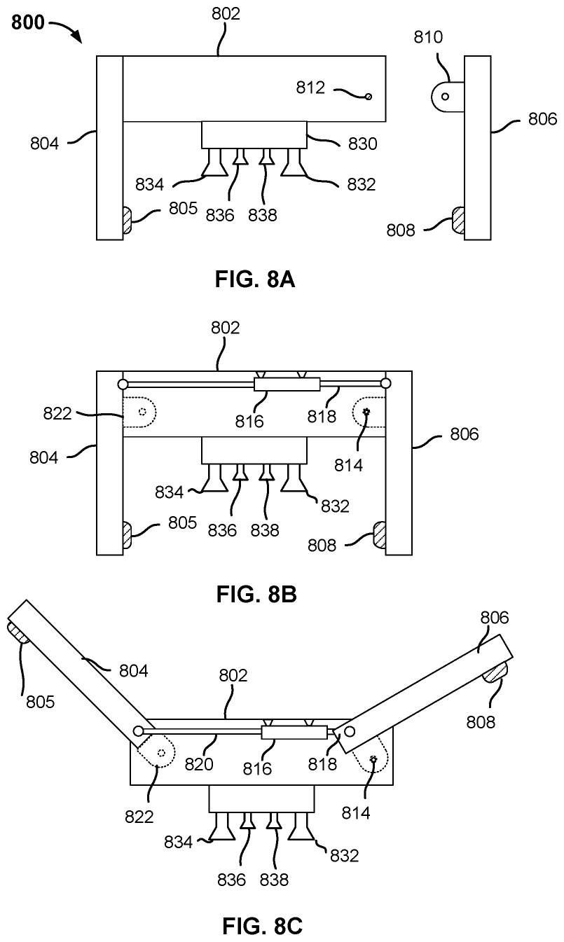

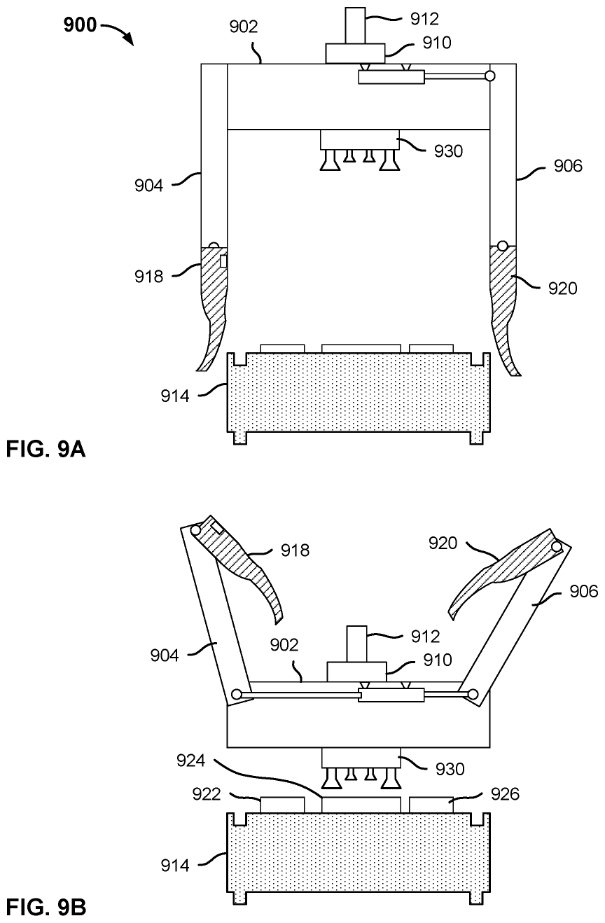

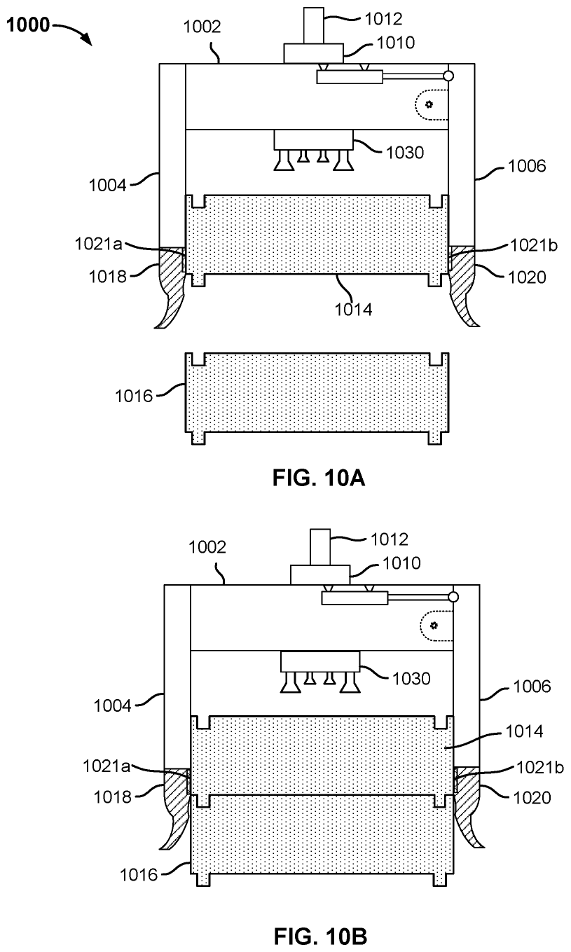

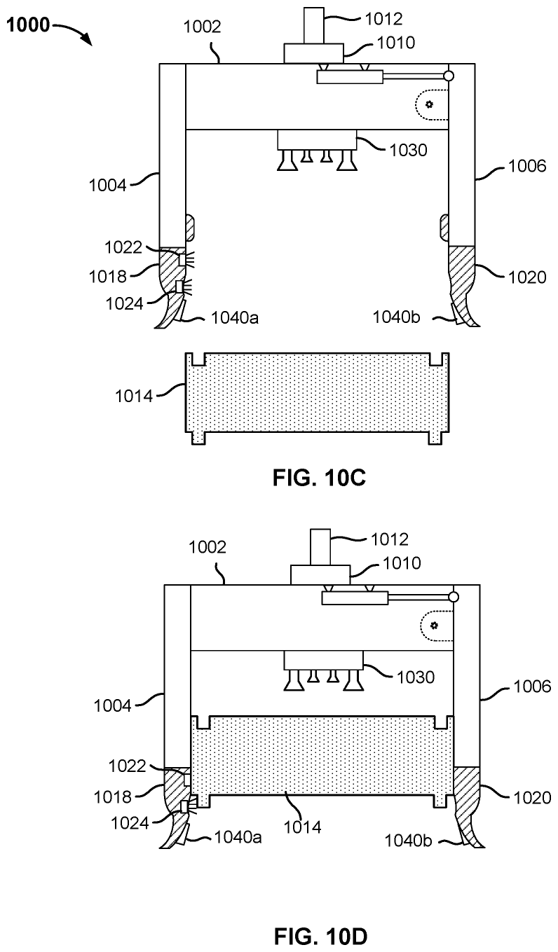

In the example shown, a single rail (e.g., rail 110) is disposed along one long side of the conveyance 106. In this example, two robots, one comprising robotic arm 112 and another comprising robotic arm 114, are mounted movably, independent of one another, on rail 110. For example, each robotic arm 112, 114 is mounted on a self-propelled chassis that rides along rail 110. In this example, each robotic arm 112, 114 terminates with a tray handling end effector (e.g., end effector 116, 118). In some embodiments, end effector 116 and/or 118 implements end effector 300 of FIGS. 3A-3C, end effector 700 of FIGS. 7A-7C, end effector 800 of FIGS. 8A-8C, end effector 900 of FIGS. 9A-9B, end effector 1000 of FIGS. 10A-10D.

In various embodiments, the tray handling end effector (e.g., end effector 116 or 118) is operated under robotic control to grasp one or more trays from a source tray stack 102, 104. In some embodiments, the tray handling end effector is comprised in a multi-mode end effector attached to robotic arm 112, 114. Examples of a multi-mode end effector include end effector 300 of FIGS. 3A-3C. The tray handling end effector my correspond to a second grasping mechanism of the multi-mode end effector. For example, the tray handling end effector comprises a plurality of gripper arms, at least a subset of which are movable to adjust a grip of a tray being picked/placed. In some embodiments, the multi-mode end effector further comprises a first grasping mechanism configured to pick and place smaller items, such as items comprised in the one or more trays moved by the tray handling end effector. As shown in FIG. 1A, each end effector 116, 118 includes a lateral member attached to the end of the robotic arm 112, 114. A side member is mounted on each end of the lateral member. As shown, at least one of the side members is opened or closed under robotic control, in various embodiments, to enable a tray to be grasped (by closing the side member) or released (by opening the side member). In some embodiments, the at least one side member that is opened or controlled under robotic control is configured to rotate around an axis perpendicular to the axis of the length of the lateral member. In some embodiments, the at least one side member that is opened or controlled under robotic control is configured to move along, or substantially along/parallel with, the axis of the length of the lateral member.

In various embodiments, each tray handling end effector 116, 118 (e.g., the second grasping mechanism of the multi-mode end effector) includes one non-moving (“passive”) side member and one movable (“active”) side member. In this example, the movable or “active” side member swings open (position in which end effector 116 is shown), e.g., to enable the end effector to be placed in position to grasp one or more trays, and swings closed (position in which end effector 118 is shown), e.g., to complete a grasp of one or more trays. In other examples, the movable or “active” side member is moved in a lateral translation substantially parallel with the length of a lateral member of the multi-mode end effector from which the “active” and “passive” side members are connected or otherwise extend. In other words, the “active” side member is moved in direction substantially corresponding to the axis of the lateral member in order to widen the grip of the second grasping mechanism or to shorten the grip of the second grasping mechanism when applying a force on a tray to be picked/placed. In various embodiments, a robotic control system (e.g., a computer that controls robotic arms 112, 114, such as control computer 128) controls the end effector to actuate the opening/closing of the end effector such as in connection with grasping or releasing a tray. The robotic control system controls the end effector based at least in part on image data of the work space and/or one or more sensors comprised in (or connected to) the corresponding end effector. In some embodiments, the one or more sensors comprised in (or connected to) the corresponding end effector are configured to: (i) obtain information indicative of whether a grasping mechanism (e.g., an active member of the second grasping mechanism) of the multi-mode effector is in an open position or a closed position, (ii) obtain information indicative of an extent to which the grasping mechanism is open, (iii) obtain information indicative of when the tray (or end effector relative to the tray) is in a position at which the multi-mode end effector is controlled to engage at least one side of the multi-mode end effector (e.g., a passive member or a structure comprised on the passive member) with a hole, a recess, or the a comprised in a side of a tray (e.g., a tray being grasped), (iv) obtain information indicative of when the tray (or end effector relative to the tray) is in a position at which the multi-mode end effector (e.g., a passive member or a structure comprised on the passive member) is engaged with the hole, the recess, or the handle comprised in the a side of a tray, (v) obtain information indicative of whether the grasping mechanism is closed or otherwise engaged with the tray, (vi) obtain information indicative of whether the second grasping mechanism is in an inactive state or an active state, (vii) obtain information indicative of whether an item is grasped by the first grasping mechanism (e.g., the suction-based end effector) of the multi-mode end effector, (viii) obtain information indicative of an attribute of the first grasping mechanism (e.g., a pressure between the suction-based end effector and the item being grasped), (ix) an indication of whether the first grasping mechanism is engaged with an object, (x) obtain information indicative of a state of the first grasping mechanism (e.g., information indicative of the state of the suction cups, such as a position of the suction cups in the case that relative positions of the suction cups can be changed to widen or shorten a distance between at least two suction cups, etc.).

In various embodiments, each end effector 116, 118 includes on each side member one or more protrusions or similar structures of a size and shape such that the protrusion, etc., fits into and, in various embodiments, can be slid under robotic control into holes or other openings in the sides the tray(s) to be grasped. For example, in some embodiments, protrusions on the inner face of the side members, sometimes called “thumbs” herein, are slotted into handholds (e.g., holes sized to accommodate a human hand) on opposite sides of a tray, as described and illustrated more fully below.

In various embodiments, the respective robotic arms 112, 114 are operated at the same time, fully autonomously, to pick trays from source tray stacks 102, 104 and place them on destination tray stacks, such as destination tray stacks 120, 122, in a destination tray stack assembly area on an opposite side of rail 110 from conveyance 106 and source tray stacks 102, 104. The destination tray stacks are assembled, in various embodiments, according to invoice, manifest, order, or other information. For example, for each of a plurality of physical destinations (e.g., retail stores), a destination stack associated with that destination (e.g., according to an order placed by the destination) is built by selecting trays from respective source tray stacks 102, 104 and stacking them on a corresponding destination tray stack 120, 122. Completed destination tray stacks 120, 122 are removed from the destination tray stack assembly area, as indicated by arrow 124, e.g., to be place on trucks, rail cars, containers, etc. for delivery to a further destination, such as a retail store.

Referring further to FIG. 1A, in the example shown in the system 100 includes a control computer 128 configured to communicate wirelessly with robotic elements comprising system 100, including in various embodiments one of more of conveyance 106; the wheeled chassis on which source tray stacks 102, 104 are stacked (if self-propelled); the robotic arms 112, 114 and/or the respective chassis on which the robotic arms 112, 114 are mounted on rail 110; and the robotically controlled tray handling end effectors (e.g., end effectors 116, 118). In various embodiments, the robotic elements are controlled by control computer 128 based on input data, such invoice, order, and/or manifest information, as well as input state information, such inventory data indicating which source tray stacks include which type and/or quantity of product.

In various embodiments, source tray stacks 102, 104 are inserted into a gate or other ingress/control structure at the input end 108 of conveyance 106. Conveyance 106 comprises an apparatus (stack mover) that moves the source tray stacks 102, 104 along the rail 110 to optimize throughput and minimize robot displacement, e.g., by minimizing how far and/or often the robotic arms 112, 114 must be moved along rail 110 to grasp source trays and place them on respective destination stacks. The source tray stacks 102, 104 can come in with trays in different orientations/weights/and weight distribution. The system 100 uses force and moment control to operate robotic arms 112, 114 to insert a thumb or other protrusion gently and securely into a tray and plans its motion and tray trajectory in order to not collide with itself or the environment. In various embodiments, each robotic arm 112, 114 operates in a very tight space of roughly 2.5 m in width and has a very light footprint. The robot utilizes its full workspace and intelligently plans its motion optimizing its grasp. The robot recognizes the need to perform orientation changes and handles that accordingly while avoiding obstacles. The robot moves to the correct output (e.g., destination tray stack 120, 122) corresponding to the right customer while coordinating with the other robots on the rail 110. The robot then uses advanced force control and interactions with the environment to figure out a proper place strategy. The cycle then restarts.

In the example shown in FIG. 1A, the system 100 includes a 3D camera 126. In various embodiments, the system 100 includes a plurality of 3D (or other) cameras, such as camera 126, and uses image and depth data generated by such cameras to generate a three-dimensional view of at least relevant portions of the workspace and scene, such as the scene/state shown in FIG. 1A. In some embodiments, cameras such as camera 126 are used to identify the contents of trays in source trays comprising a tray stack, e.g., by recognizing the size, shape, packaging, and/or labeling of such items, and/or by recognizing the shape, color, dimensions, or other attributes of the source stack trays themselves and/or by reading bar code, QR code, radio frequency tag, or other image or non-image based information on or emitted by the trays.

In various embodiments, image data generated by cameras such as camera 126 is used to move robotic arms and end effectors into a position near a tray or stack of two or more trays to be grasped and picked up from a source stack and/or to position the tray(s) near a destination at which they are to be place, e.g., at the top of a corresponding destination stack. In some embodiments, force control is used, as described more fully below, to complete the final phases of a pick/grasp episode and/or a placement episode.

Although a single camera (e.g., camera 126) mounted to a wall in the workspace of system 100 is shown in FIG. 1A, in various embodiments, multiple cameras or other sensors, or a combination thereof, are mounted statically in a workspace. In addition, or instead, one or more cameras or other sensors are mounted on or near each robotic arm 112, 114, such as on the arm itself and/or on the end effector 116, 118, and/or on a structure that travels with the robotic arm 112, 114 as it is moved along rail 110.

FIG. 1B is a block diagram illustrating an embodiment of a robotic line kitting system. In FIG. 1B, an example is shown of an overhead view of a workspace in which the system 100 of FIG. 1A may operate. In the example shown, robotic arms 112, 114 move along a common rail (e.g., rail 110), as in FIG. 1A, to access and pick trays from source stacks 140 moving along conveyance 106 and play trays on corresponding destination stacks 142 in the destination stack assembly area on the opposite side of rail 110 from the source stacks 140 and conveyance 106. In this example, a human worker manually feeds source stacks onto the conveyance 106, but in some embodiments a robotic worker performs all or part of that task, e.g., according to plan generated programmatically to fulfill a set of orders, each associated with a corresponding destination. As destinations stacks 142 are completed, they are moved out of the destination stack assembly area, as indicated by the arrows that the top of FIG. 1B, which corresponding to arrow 124 of FIG. 1A.

While in the example shown in FIGS. 1A and 1B the trays each contain only one type of time, in other embodiments and applications source and destination trays having mixes of items may be handled to assemble destination stacks of trays as disclosed herein. Similarly, while in the example shown in FIGS. 1A and 1B the source stacks of trays each contain only trays of the same type and content, in other embodiments and applications source tray stacks may include a mix of trays and/or item types. For example, the control computer 128 is provided with information indicating which types of trays are in which position in each source tray stack, and uses that information, along with manifest or other information indicating the required contents of each destination tray stack, to build the required destination tray stacks by picking needed trays each from a corresponding position on a source tray stack and adding the tray to a corresponding destination stack.

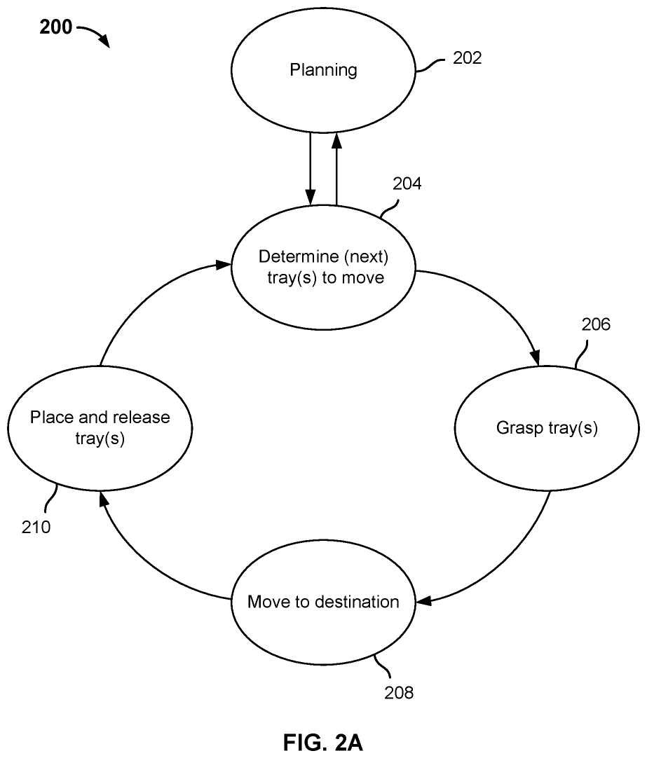

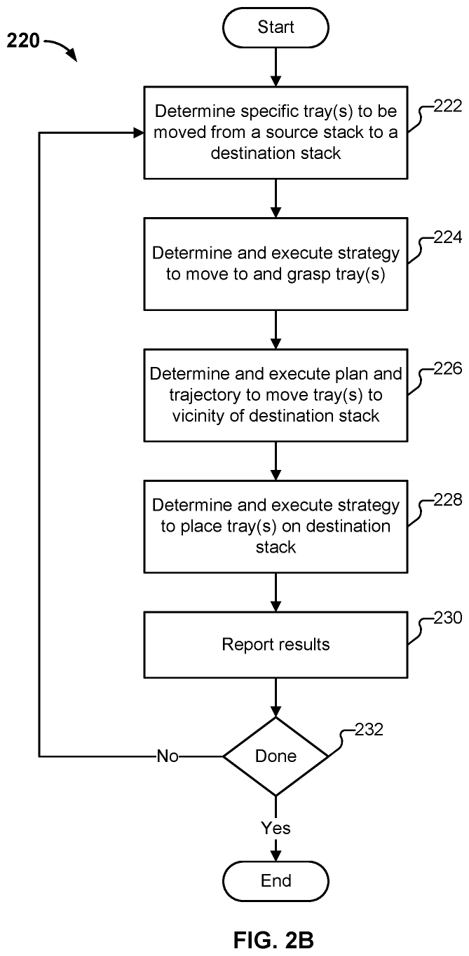

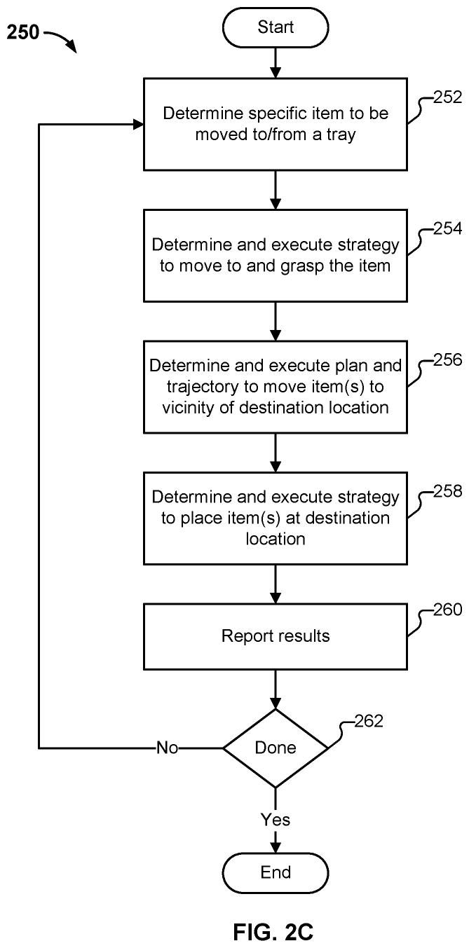

FIG. 2A is a state diagram illustrating an embodiment of an automated process to assemble stacks of trays. In various embodiments, processing according to the state diagram 200 is performed by a control computer, such as control computer 128 of FIG. 1A. In the example shown, a planning state, process, and/or module 202 generates and dynamically updates a plan to assemble output stacks of trays by using robotic instrumentalities as disclosed herein to pick trays from homogeneous or non-homogeneous source stacks of trays and building destination stacks each having one or more types of trays, e.g., according to a set of orders, invoices, manifests, etc. The planning state, process, and/or module 202 receives feedback indicating which destination tray stacks have been completed, which stacks of source trays have been moved into the workspace, and/or other state and context information which can be used to continuous update the plan to pick and place (stack) trays to assemble the destination stacks. In state 204, a process controlling a given robotic instrumentality (e.g., robotic arms 112 and/or 114 and associated end effectors 116 and 118, in the example shown in FIG. 1A) determines a next set of one or more trays to be move from a source stack to a destination stack according to a current overall plan as received from planning state, process, and/or module 202. For example, the robot determines to grasp one, two, or more trays from a source stack to add them to (or start a new) destination stack. The robot enters state 206, in which a strategy and plan is determined to do one or more of move into position to grasp the tray(s), grasp the trays, and/or begin to move them toward the destination stack location is formed; and the robot moves into position and grasps the trays. Once the tray(s) has/have been grasped, the robot enters state 208 in which the tray is moved along a planned (and, if needed, dynamically adapted) trajectory to the vicinity of the destination stack, e.g., a position hovering over the destination stack and/or a location or structure on which the destination stack is to be built. In state 210, the robot place(s) the tray(s) on the destination stack. In some embodiments, the state 210 includes maneuvers under force control to verify the tray(s) is/are place securely on the destination stack, e.g., by moving (or attempting to move) the tray(s) forward and backward (or side to side, as applicable) to ensure any interconnecting structures are aligned and well slotted, such as tabs on the bottom of the trays being placed fitting into corresponding recesses in the side walls of the tray on which the tray(s) is/are being placed. Once the trays are determined to have been placed securely, the robot releases the tray(s) and reenters the state 204, in which a next set of one or more trays is determined to be picked from a corresponding source stack and moved to a corresponding destination stack, e.g., according to overall plan information received from planning state, process, and/or module 202. In various embodiments, a robotic system as disclosed herein continues to cycle through the states 204, 206, 208, and 210 of FIG. 2A until all destination stacks have been assembled.

FIG. 2B is a flow diagram illustrating an embodiment of an automated process to assemble stacks of trays. In various embodiments, a process or module controlling one or more tray handling robots implements the process 220 of FIG. 2B. In various embodiments, the process 220 of FIG. 2B is performed by process or module running on a control computer, such as control computer 128 of FIG. 1A. In some embodiments, process 220 is performed in connection with using a second grasping mechanism of a multi-mode end effector (e.g., a grasping mechanism with gripper arms, etc.) to grasp a tray. In the example shown, at 222 a specific set of one or more trays is determined to be moved from a source stack to a destination stack. In some embodiments, a robotic arm has an end effector (e.g., a second grasping mechanism) that accommodates picking and placing only one tray at a time. In other embodiments, a robot has an end effector that can grasp a stack of two or more trays, e.g., by grasping a bottommost one of the trays in the stack to be grasped. At 224, a strategy to move to and grasp the tray(s) is determined. For example, the robot plans and implements a set of maneuvers to move its end effector to a position above or otherwise near the tray(s) to be grasped. As another example, the robot plans and implements an operation to control the end effector to grasp trays. The robot controls the end effector (e.g., a multi-mode end effector) to change modes in connection with grasping a tray or item from the tray (e.g., to control the end effector to use a first grasping mechanism or second grasping mechanism based at least in part on whether the end effector is to grasp a tray or an item from a tray, etc.). A strategy to grasp the tray(s) is determined and implemented. At 226, a plan (e.g., trajectory) to move the tray(s) to a destination stack is determined and executed. The trajectory/plan takes into consideration obstacles in the workspace, such as other stacks, and potential conflicts with other robotic instrumentalities, such as another pick/place robot operating in the same workspace (e.g., robotic arms 112, 114 of FIG. 1A). At 228, a strategy to place the tray(s) atop the corresponding destination stack is determined and executed. At 230, results of the pick/place operation are reported, e.g., to a planning process or module. Subsequent iterations of steps 222, 224, 226, 228, and 230 are repeated until it is determined at 232 that processing is done, e.g., all destination stacks have been completed.

FIG. 2C is a flow diagram illustrating an embodiment of an automated process to pick and place items to/from a tray. In some embodiments, process 250 is implemented by system 100 of FIG. 1A. In some embodiments, process 250 is performed in connection with using a first grasping mechanism of a multi-mode end effector (e.g., a grasping mechanism with suction cups for suction-based grasping, etc.) to pick/place an item from/to a tray. In various embodiments, a process or module controlling one or more tray handling robots implements the process 220 of FIG. 2B. In various embodiments, the process 220 of FIG. 2B is performed by process or module running on a control computer, such as control computer 128 of FIG. 1A.

In the example shown, at 252 a specific set of one or more items is determined to be moved from a source location to a destination location. For example, the system determines to retrieve the item from a source location (e.g., a kitting shelf, conveyor, etc.) and place an item in a tray or other receptacle. As another example, the system determines to pick the item from a tray and place the item at a destination location (e.g., conveyor, chute, other receptacle, etc.). In some embodiments, a robotic arm has an end effector (e.g., a first grasping mechanism such as a suction-based end effector) that accommodates picking and placing only one item at a time. In other embodiments, a robot has an end effector that can grasp a plurality of items (e.g., by grasping each of the items using a different subset of suction cups of the suction-based end effector).

At 254, a strategy to move to and grasp the item is determined. For example, the robot plans and implements a set of maneuvers to move its end effector (e.g., a suction-based end effector of a multi-mode end effector) to a position above or otherwise near the item(s) to be grasped. As another example, the robot plans and implements an operation to control the end effector to grasp items. The robot controls the end effector (e.g., a multi-mode end effector) to change modes in connection with grasping a tray or item from the tray (e.g., to control the end effector to use a first grasping mechanism or second grasping mechanism based at least in part on whether the end effector is to grasp a tray or an item from a tray, etc.). A strategy to grasp the item(s) is determined and implemented.

At 256, a plan (e.g., trajectory) to move the item(s) to a destination location is determined and executed. The trajectory/plan takes into consideration obstacles in the workspace, such as other items, stacks of trays, and potential conflicts with other robotic instrumentalities, such as another pick/place robot operating in the same workspace (e.g., robotic arms 112, 114 of FIG. 1A).

At 258, a strategy to place the items at the corresponding destination location (e.g., a destination tray, a conveyor, etc.) is determined and executed.

At 260, results of the pick/place operation are reported, e.g., to a planning process or module. Subsequent iterations of steps 252, 254, 256, 258, and 260 are repeated until it is determined at 262 that processing is done, e.g., all item(s) have been picked and placed (e.g., items corresponding to a manifest such as an order or packing slip, or the tray from which the items are picked is empty, or the tray in which the items are placed is full).

FIG. 3A is a diagram illustrating an embodiment of a robotically controlled tray handling end effector. In some embodiments, end effector 300 is implemented in connection with system 100 of FIG. 1A such as by robot arms 112, 114. End effector 300 is a multi-mode end effector comprising at least two grasping mechanisms (e.g., a first grasping mechanism and a second grasping mechanism). In some embodiments, end effector 300 is robotically controlled to operate according to different modes, such as based on a task to be performed. For example, end effector 300 operates in a first mode in which a first grasping mechanism (e.g., a suction-based end effector is used to pick/place an item). As another example, end effector 300 operates in a second mode in which a second grasping mechanism (e.g., an end effector having gripper arms is used to pick/place a tray). As another example, end effector 300 operates in a third mode in which a structure on end effector 300 is used to push/pull a tray or a stack of trays.

In the example shown, end effector 300 includes a plurality of grasping mechanisms. In some embodiments, end effector 300 comprises (i) a first grasping mechanism corresponding to a suction-based end effector 314, and (ii) a second grasping mechanism comprising gripper arms (e.g., side members). The different grasping mechanisms comprised in end effector 300 is used for different functions or in different modes. Suction-based end effector 314 comprises one or more suction cups 314a, 314b, 314c, and 314d. In some embodiments, end effector 300 is robotically controlled to grasp objects (e.g., trays, items in trays, etc.) based on selectively controlling one or more of the first grasping mechanism and the second grasping mechanism.

As illustrated in FIG. 3A, end effector 300 comprises a lateral member 302 to the first grasping mechanism and/or a plurality of elements for the second grasping mechanism are mounted. For example, end effector 300 comprises lateral member 302 which a side member 304 is fixedly mounted and an side member 306 is hinge or otherwise movably mounted in a manner that enables side member 306 (e.g., active side member) to be moved to an open position that facilitates moving the end effector 300 into a position to grasp a tray. An active side thumb 308 is positioned on (or comprises an integral part or feature of) an inner face of side member 306. In some embodiments, both gripper arms (e.g., side members) are movable with respect to lateral member 302 such as in connection with extending or shortening a grip between the gripper arms.

According to various embodiments, side member 306 is movable within a predefined range of motion. As an example, end effector 300 includes one or more stopping mechanisms (e.g., stopper, switch, or the like, or a combination thereof) that restrict movement of the side member 306 to within the predefined range of motion. End effector 300 includes an open-position stopping mechanism that prevents side member 306 from moving in an opening direction past an open position threshold (e.g., 130 degrees relative to a plane/vector along which lateral member 302 extends in a lengthwise direction, or between 30 and 50 degrees relative to a closed position at which active member 306 is substantially normal to the plane/vector along which lateral member 302 extends). End effector 300 includes a closed-position stopping mechanism that prevents side member 306 from moving in an closing direction past a closed position threshold (e.g., about 90 degrees relative to a plane/vector along which lateral member 302 extends in a lengthwise direction, etc.). Various values can be selected for the open position threshold and/or the closed position threshold. In some embodiments, the open position threshold is set based at least in part on an environment in which the robot to which end effector 300 is connected operates. As an example, if a plurality of robots are operating within a relatively close proximity, the range of motion of the side member 306 is based at least in part on a distance between robots or between zones in which the various robots (e.g., neighboring robots) operate. As the side member 306 moves from a closed position to an open position the further the side member 306 extends in the x-direction. In addition, the further the side member 306 is movable from the closed position to the open position, the greater the time required for the robotic system to control to open/close side member 306 in connection with grasping/placing a tray(s). Accordingly, limiting the range of motion of the side member 306 (e.g., to a sufficient open position threshold to permit the end effector to grasp a set of one or more tray(s) with ease) allows the robotic system to operate more efficiently within proximity of other robots (e.g., other robots that are autonomously grasping, moving, and placing trays).

In some embodiments, the open position threshold and/or the closed position threshold are configurable. For example, the one or more stopping mechanisms are configurable and set based on the desired the open position threshold and/or the closed position threshold configuration(s).

The active side thumb 308 and a corresponding structure on the inner face of side member 304, not visible in FIG. 3A, are of a size and shape suitable to be inserted into a handhold or other recess or hole on opposite sides of a tray to be grasped by the end effector 300. In various embodiments, the thumbs 308 are removable and replaceable, e.g., to be replaced once they are worn out from use or to be exchanged with a thumb having a different shape, dimensions, materials, etc. suitable to grasp a different type of tray, for example. Active side thumb 308 is fixedly mounted to side member 306 such as to impede thumb 308 from rotating (e.g., during engagement with tray handle, etc.). For example, active side thumb is mounted to side member 306 at three mounting points. Various other mounting configurations or number of mounting points may be implemented. As shown in the three-view drawing to the right of FIG. 3A, in the example shown the thumb 308 has convex surfaces 308a-d on each of four sides. In various embodiments, the convex surfaces 308a-d facilitate using force and moment control to insert the thumb 308 into a handle or other hole or recess in the side of a tray to be grasped. In some embodiments, the convex surfaces are used in conjunction with active force control and orientation impedance control to ensure a gentle and secure final grasp, where the active side is fully into the tray. For example, even if imperfectly aligned, a convex surface 308a-d engaged in a side or edge of a hole enables the rest of the thumb 308 to more readily be slid more fully into the hole. Flat surfaces 308e at the base of the thumb, nearest the inner side wall of the side member 304, 306 on which the thumb 308 is mounted, in various embodiments enable misalignment to between the end effector 300 and the tray(s) being grasped to be corrected and/or alignment refined. For example, in a picking episode, a thumb of the side member 304 (e.g., the passive side member) is moved into position near a handle or other hole on one side of the tray to be grasped. The convex surfaces 308a-d are used, under force control, to slide the thumb partway into the hole. The flat surfaces 308e near the base of the thumb are to better align the passive side with the tray prior to closing the side member 306.

Referring further to FIG. 3A, in the example shown end effector 300 includes a force sensor 310 mounted on lateral member 302 and bracket 312 to attach the end effector 300 to a robotic arm. In some embodiments, end effector 300 is attached to a robotic arm via a pin inserted through a hole in bracket 312, enabling the end effector 300 to swing freely and/or be rotated under robotic control, e.g., using one or more motors, about a longitudinal axis of the pin. In various embodiments, force sensor 310 detects forces/moments experienced by end effector 300 in an x, y, and/or z direction. Force sensor 310 may have a single axis overload of force in the x or y direction (e.g., Fxy) of at least +10000 N and/or a single axis overload of force in the z direction of at least +30000 N (e.g., Fz). Force sensor 310 may have a single axis overload of torque in the x or y direction (e.g., Txy) of at least +1000 Nm and/or a single axis overload of torque in the z direction of up to at least +1000 Nm (e.g., Tz). In some embodiments, force sensor 310 has a single axis overload of force in the x or y direction (e.g., Fxy) of about +18000 N and/or a single axis overload of force in the z direction of about +48000 N (e.g., Fz); and a single axis overload of torque in the x or y direction (e.g., Txy) of about +1700 Nm and/or a single axis overload of torque in the z direction of about +1900 Nm (e.g., Tz).

In various embodiments, side member 304 is fixedly mounted to lateral member 302. The fixed mounting of the side member 304 enables forces and moments acting on end effector 300 (e.g., on side member 304) to propagate through the frame of the end effector (e.g., lateral member 302 and side member 304) to force sensor 310. For example, the fixed mounting of the side member 304 avoids forces and movements from translating into a movement of other parts of the end effector such as active member 306 when active member 306 is being actuated to move thumb 308 to engage with a tray handle (e.g., to insert thumb 308 into the tray handle).

FIG. 3B is a diagram illustrating an embodiment of a robotically controlled tray handling end effector. End effector 300 comprises a second grasping mechanism that is controlled (e.g., during the second mode of operation of the multi-mode operation) to grasp items using gripper arms (e.g., side members 304, 306). In some embodiments, end effector 300 is controlled to move one or more of the gripper arms to open a grip to allow end effector 300 to move into position to grasp an object (e.g., a tray) and to move one or more of the gripper arms to close the grip on the object to be grasped.

In the state shown in FIG. 3B, the active side member 306 has been opened to the open position, e.g., by a pneumatic or hydraulic piston, motor, or other motive force and structure housed in lateral member 302 (not shown) in FIG. 3B. Vector/direction 316 illustrates an example of a closed position (e.g., the closed position threshold). In various embodiments, the closed position is a configuration according to which side member 306 forms a normal vector relative to lateral member 302. For example, the closed position threshold is 90 degrees (or substantially 90 degrees) relative to a direction along which lateral member 302 extends. As illustrated in FIG. 3B, side member 306 is moved to an open position. As side member 306 is moved to the open position, an angle between side member 306 and vector/direction 316 is represented as angle 313. According to various embodiments, the open position threshold corresponds to a configuration at which angle 313 is between 35 degrees and 50 degrees. In some embodiments, open position threshold corresponds to a configuration at which angle 313 is between 40 degrees and 50 degrees. In some embodiments, open position threshold corresponds to a configuration at which angle 313 is between about 40 degrees and about 45 degrees.

In various embodiments, robotic system controls side member 306 (e.g., controls an actuation device to move side member 306) based at least in part on information obtained by one or more sensors, such as a sensor(s) comprised in side member 306 (e.g., thumb 308 of side member 306), a sensor(s) comprised in side member 304 (e.g., a thumb of passive side member), a camera or other sensor comprised on or around the robot to which end effector 300 is connected (e.g., to capture information pertaining to the workspace of the robot), and the like, or any combination thereof. Side member 306 is controlled according to a plan to grasp, move, and/or place a set of one or more trays and the information obtained from the one or more sensors. Side member 306 is further controlled according to obstacles within the workspace of the robot such as another stack of trays (e.g., an adjacent stack), another robot working to remove a tray another stack of trays (or of the same tray).

In various embodiments, tray pick operations as disclosed herein are smooth, gentle, and precise and are tolerant to uncertainty and disturbances. In various embodiments, a pick episode using the second grasping mechanism (e.g., grasping a tray using gripper arms) includes one or more of:
Lowering to a target pose (adjacent tray) from the hover pose (above stack) coupled with height checks to refine estimation of where the tray handle is and a dynamic goal adjustment.
Using the active side surface of the end effector to control any uncertainties in the direction of the rail be it a misplaced tray or a human error. In various embodiments, after moving to the hover pose, the robot lowers into the position to align with the handle, and while it does this lowering motion, force control is used to ensure that the alignment in the rail direction is perfect (or substantially perfect). This can be very likely because the gripper almost perfectly fits the length of the tray in between itself, and any misalignment can lead to contact. This contact is ensured to be on the active side panel, which has a diagonal plane—meaning that the robotic system can effectively use the contact between the gripper and the misaligned trays to adjust our position using force control.
Proceeding to use a three degree of freedom (3 DOF) force controller (e.g., based on sensor readings from force sensor 310) to find the position of the (tray handle) slot on the passive side and insert the passive side thumb into the slot using the convexity of the thumb (e.g., one or more of surfaces 308 a-d, depending on which engage with the tray). In some embodiments, a 6DOF controller is used to perform XYZ force control to ensure that the thumb is inserted and XYZ axis moment to ensure that the plane of the passive side panel is flush against the plane of the tray outer surface. In some embodiments, one or more sensors in side member 304 (or in the thumb of side member 304) are used to obtain information associated with a location of the tray, such as information indicating a position of the second side member relative to the first tray, information indicative of when the first tray is in a position at which the end effector is controlled to engage the passive-side structure with the hole (e.g., to detect when the tray is in proximity of the tray such as at an entry of the gripper such as for detection that end effector 300 is properly positioned to begin a process of engaging the tray with side member 304, etc.), the recess, or the handle comprised in the first structure, information indicative of when the first tray is in a position at which the passive-side structure is engaged with the hole, the recess, or the handle comprised in the first structure, and the like, or any combination thereof.
Using the flat extremities (e.g., 308e) of the thumbs to adjust for any orientation mismatch.
When all is good (e.g., in response to a determination that the side member 304 and/or active side member is positioned properly to grasp the tray, etc.), close the active side (e.g., 306) with force/moment control, to account for any residual orientation or positional uncertainty in the tray pose, and lift the tray up to make sanity checks for the quality of the grasp (e.g., weight as expected, forces and moments balanced and otherwise consistent with good grasp). In some embodiments, when the state of the gripper is deemed good, the active side is closed with force/moment control enabled in order to refine and correct for any residual orientation/position errors, which ensure gentle handling of the tray.

The robot safely aborts the pick if it detects any anomalies related to weight or quality of the trays in the stack or the quality of the stacking itself.

According to various embodiments, end effector 300 is controlled to actuate a second grasping mechanism between an active state (e.g., a deployed state) and an inactive state (e.g., a retracted state). As an example, when end effector 300 is controlled to operate in a first mode (e.g., to use a first grasping mechanism to grasp an item from a tray), the second grasping mechanism is actuated to be configured in an inactive state. During operation in the first mode, end effector 300 is transitioned to the inactive state in which one or more elements of the second grasping mechanism are moved to allow the first grasping mechanism to grasp the object (e.g., the item in a tray, etc.). As another example, when end effector 300 is controlled to operate in a second mode (e.g., to use a second grasping mechanism to grasp a tray), the second grasping mechanism is actuated to be configured in an active state. During operation in the second mode, end effector 300 is transitioned to the active state in which one or more elements of the second grasping mechanism are moved to allow the gripper arms to engage a tray or other object grasped by the second grasping mechanism.

FIG. 3C is a diagram illustrating an embodiment of a robotically controlled tray handling end effector. End effector 300 comprises a second grasping mechanism that is controlled (e.g., during the second mode of operation of the multi-mode operation) to grasp items using gripper arms (e.g., side members 304, 306). In some embodiments, end effector 300 is controlled to move one or more of the gripper arms to open a grip to allow end effector 300 to move into position to grasp an object (e.g., a tray) and to move one or more of the gripper arms to close the grip on the object to be grasped.

In some embodiments, during operation of end effector 300 in the first mode, end effector transitioned to the inactive state in which elements (e.g., the gripper arms) are moved to a fully retracted state. As illustrated in FIG. 3C, side members 304,306 are positioned in an active state in which side members 304, 306 are fully retracted and enable suction-based end effector 314 (e.g., the first grasping mechanism such as a suction-based end effector) to grasp an item.

Vector/direction 316 illustrates an example of a closed position (e.g., the closed position threshold) corresponding to end effector 300 being operated in the second mode (e.g., in which the gripper arms are positioned in the active state). In various embodiments, the closed position is a configuration according to which side member 306 forms a normal vector (or substantially a normal vector) relative to lateral member 302 and extends away from a part of lateral member 302 that is mounted to a robotic arm. For example, the closed position threshold is 90 degrees (or substantially 90 degrees) relative to a direction along which lateral member 302 extends. As illustrated in FIG. 3C, side members 304, 306 are moved to an open position (e.g., a retracted state). As side members 304, 306 are moved to the open position, an angle between side member 306 and vector/direction 316 is represented as angle 315. According to various embodiments, the open position threshold corresponds to a configuration at which angle 313 is between 145 degrees and 225 degrees. In some embodiments, open position threshold corresponds to a configuration at which angle 313 is between 180 degrees and 225 degrees.

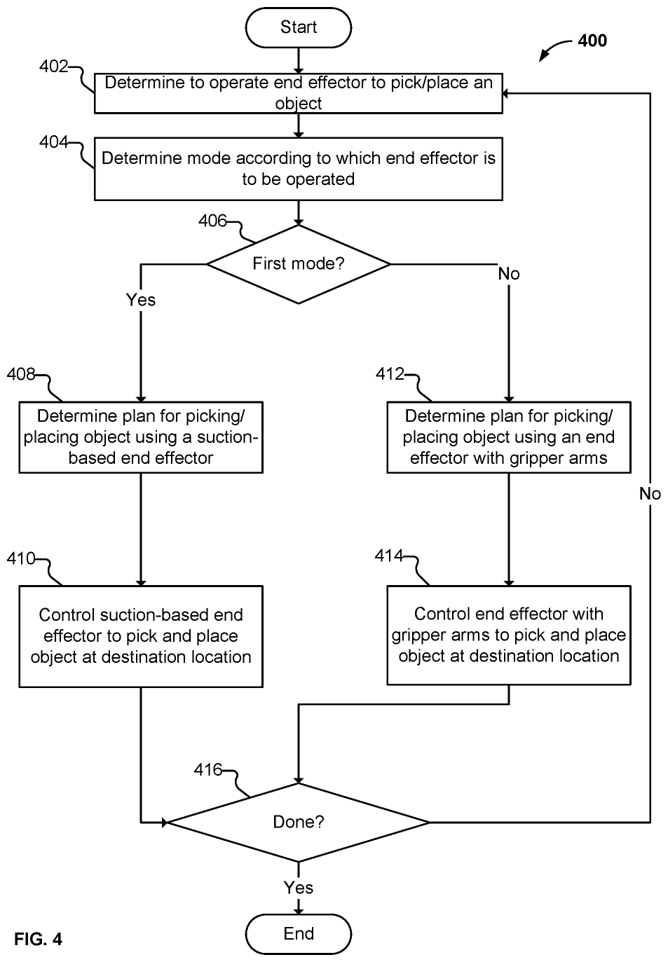

FIG. 4 is a flow diagram of a process for operating an end effector to move an object according to various embodiments. In some embodiments, process 400 is implemented in connection with controlling end effector 300 of FIGS. 3A-3B. In some embodiments, process 400 is implemented by system 100 of FIG. 1A, etc.

At 402, a determination is made to operate the end effector (e.g., a multi-mode end effector) to pick/place an object. In some embodiments, an object may be a tray, a receptacle, a tote, a box, an item (e.g., an item that can be included in a tray), etc.

At 404, a mode according to which the end effector is to be operated is determined. The system selects, from a plurality of modes, the mode according to which the end effector is to be operated. In some embodiments, the system determines whether to operate the end effector in a first mode according to which a first grasping mechanism (e.g., a suction-based end effector) is used to grasp the object, and/or whether to operate the end effector in a second mode according to which a second grasping mechanism (e.g., an end effector comprising a plurality of gripper arms) is used to grasp the object.

At 406, a determination is made as to whether the end effector is to operated is the first mode. In response to determining that the end effector is to be operated in the first mode at 406, process 400 proceeds to 408. Conversely, in response to determining that the end effector is not to be operated in the first mode at 406, process 400 proceeds to 412.

At 408, a plan for picking/placing an object using a suction-based end effector is determined. In response to determining to operate the end effector in the first mode, the system determines a plan (or strategy) for grasping the object such as an item comprised in a tray or other receptacle and for placing the object at a destination location (e.g., a tray, a conveyor, a shelf, etc.). In some embodiments, in response to determining to operate the end effector in the first mode, the system controls the end effector to transition the second grasping mechanism to an inactive state (e.g., in which the gripper arms are moved to a retracted position). The plan determined for grasping the object can include an operation to transition the second grasping mechanism to the inactive state.

At 410, the suction-based end effector is controlled to pick and place an object at a destination location. The system controls the suction-based end effector to actuate a suction mechanism to apply a suction force between a suction cup of the suction-based end effector and the object to be grasped. The system controls the suction mechanism based at least in part on feedback received by a sensor that detects a suction force (or other attribute of the suction between the suction cup and the object). In some embodiments, controlling the suction-based end effector to pick and place the object comprises controlling a robotic arm to which a multi-mode end effector is mounted to use a suction-based end effector thereof to pick and place the object.

At 412, a plan for picking/placing the object using an end effector comprising gripper arms is determined. In response to determining to operate the end effector in the second mode, the system determines a plan (or strategy) for grasping the object such as a tray (e.g., a tray comprised in a stack of trays, etc.). In some embodiments, in response to determining to operate the end effector in the second mode, the system controls the end effector to transition the second grasping mechanism to an active state (e.g., in which the gripper arms are moved to a deployed position). The plan determined for grasping the object can include an operation to transition the second grasping mechanism to the active state.

At 414, the end effector comprising gripper arms is controlled to pick and place an object at a destination location. The system controls the end effector comprising gripper arms (e.g., the second grasping mechanism) to actuate movement of one or more of the gripper arms to grip the object (e.g., the tray) to be grasped. For example, the system controls to move an active side member to engage the object. The system controls the end effector comprising gripper arms based at least in part on feedback received by a sensor that detects positioning of one or more gripper arms (or thumbs of such arms) relative to the object to be grasped. In some embodiments, controlling the end effector comprising gripper arms to pick and place the object comprises controlling a robotic arm to which a multi-mode end effector is mounted to use the gripper arms thereof to grasp, and pick/place the object.

At 416, a determination is made as to whether process 400 is complete. In some embodiments, process 400 is determined to be complete in response to a determination that no further objects (e.g., trays, items) are to be moved, a tray held by a task table is empty (e.g., in the case of an unloading operation), a tray held by a task table is full (e.g., int eh case of a loading operation), a user has exited the system, an administrator indicates that process 400 is to be paused or stopped, etc. In response to a determination that process 400 is complete, process 400 ends. In response to a determination that process 400 is not complete, process 400 returns to 402.

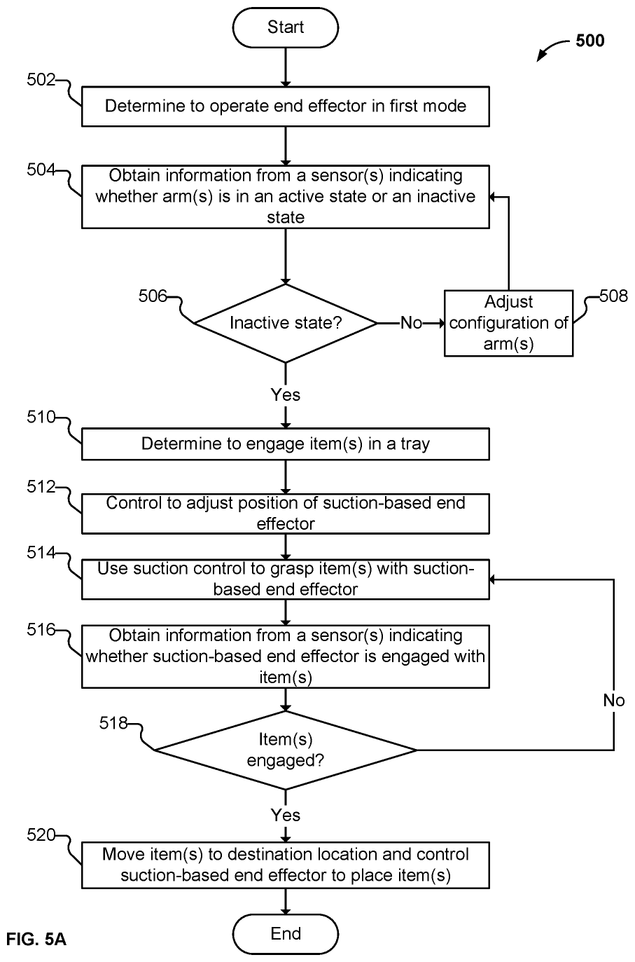

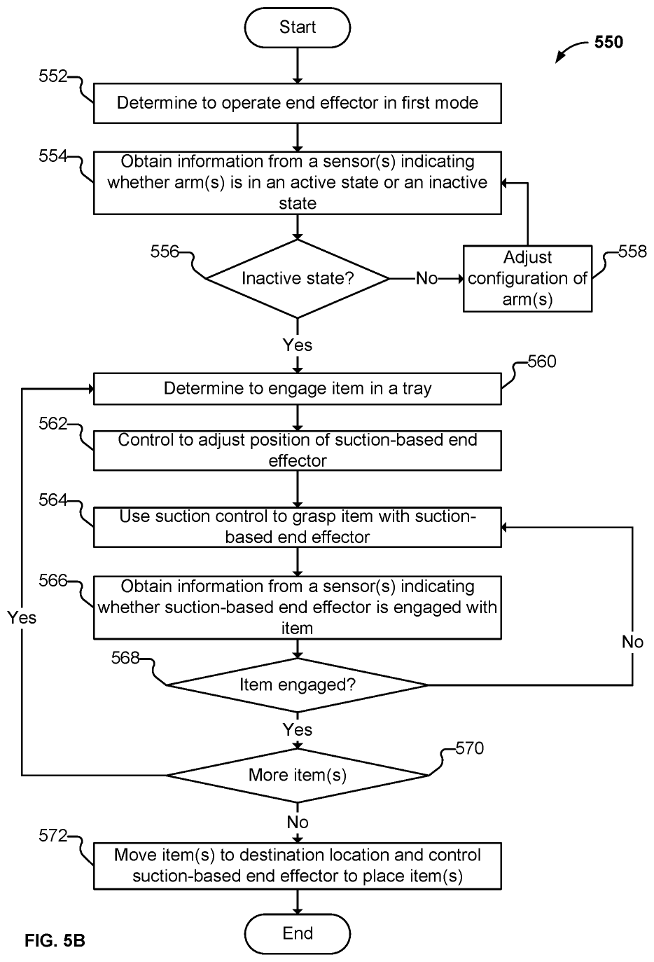

FIG. 5A is a flow diagram of a process for operating an end effector in connection with picking or placing an item to/from a tray according to various embodiments. In some embodiments, process 500 is implemented in connection with controlling end effector 300 of FIGS. 3A-3B. In some embodiments, process 500 is implemented by system 100 of FIG. 1A, etc.

At 502, a determination is made to operate the end effector (e.g., a multi-mode end effector) in a first mode. In some embodiments, the system determines to operate the multi-mode end effector in the first mode in connection with determining that the object to be grasped is an item to be picked/placed from/to a tray, or otherwise determining that the object is to be grasped with a suction-based end effector.

At 504, information is obtained from one or more sensors. The information indicates whether one or more of the gripper arms is in an active state or an inactive state (or some intermediate state between the inactive state or inactive state). In some embodiments, the system uses the information corresponding to a positioning of the gripper arms in connection with controlling the gripper arms (or second grasping mechanism) to transition to the active state or inactive state according to a mode in which the multi-mode end effector is to be operated.

At 506, a determination is made as to whether the gripper arms are positioned in the inactive state. In response to determining that the gripper arms are not in the inactive state (or determining that the gripper arms are in the active state) at 506, process 500 proceeds to 508 at which a configuration of the gripper arms is adjusted. For example, the system controls to move (or continue to move) the gripper arms to the inactive state (e.g., to the retracted position). In some embodiments, the inactive state corresponds to the gripper arms are positioned in a threshold retracted state such as within a range of angles between the gripper arms and the lateral member (e.g., the gripper arms is deemed to be in an inactive state even if the gripper arms are not fully retracted but are within a threshold of retraction of the gripper arms). Process 500 iterates over 504-508 until the system determines that the gripper arms are in the inactive state.

In response to determining that the gripper arms are in the inactive state at 506, process 500 proceeds to 510 at which the system determines to engage the item such as an item within a tray or other source location (e.g., shelf, conveyor, etc.).

At 512, the system controls to adjust a position of the suction-based end effector (e.g., the first grasping mechanism). The system controls to position the suction-based end effector to engage the item to be grasped. For example, the system moves the robotic arm and end effector to a position at which a suction-cup on the suction-based end effector engages the item.

At 514, the system uses suction control to grasp the item(s) with the suction-based end effector. The system actuates a suction mechanism to apply a suction force between one or more suction cups (e.g., comprised in the suction-based end effector) and the item(s) to be grasped. In some embodiments, the suction-based end effector is controlled to grasp a plurality of items (e.g., to simultaneously move the plurality of items to respective destination location).

At 516, information is obtained from one or more sensors. The information indicates whether the suction-based end effector is engaged with the item(s) to be grasped. For example, the system obtains information pertaining to a suction force between the suction cup(s) of the suction-based end effector and the item(s) to be grasped.

At 518, the system determines whether the item(s) is engaged. For example, the system determines whether the item(s) are securely grasped by the suction-based end effector. In response to determining that the item(s) is not securely grasped (e.g., a suction force between the item and the end effector is less than a threshold suction force, or that the item is not engaged with the suction-based end effector) at 518, process 500 returns to 514 at which the system uses the suction control to adjust/secure engagement/grasping of the item using the suction-based end effector. Process 500 iterates over 514-518 until the system determines that the item(s) is securely grasped by the suction-based end effector.

At 520, the item(s) is moved to the destination location and the suction-based end effector is controlled to place the item(s). In some embodiments, the system controls a robotic arm to move the item to the destination location (or proximity of the destination location) and then controls the suction-based end effector to release the item at the destination location. For example, the system controls the suction-based end effector to reduce/eliminate the suction force between the suction-based end effector and the item(s).

FIG. 5B is a flow diagram of a process for operating an end effector in connection with picking or placing an item to/from a tray according to various embodiments. In some embodiments, process 550 is implemented in connection with controlling end effector 300 of FIGS. 3A-3B. In some embodiments, process 550 is implemented by system 100 of FIG. 1A, etc.

At 552, the system determines to operate the end effector in a first mode. In some embodiments, 552 corresponds to, or is similar to, 502 of process 500 of FIG. 5A.

At 554, information is obtained from one or more sensors. In some embodiments, 554 corresponds to, or is similar to, 504 of process 500 of FIG. 5A.

At 556, a determination is made as to whether the gripper arms are positioned in the inactive state. In some embodiments, 556 corresponds to, or is similar to, 506 of process 500 of FIG. 5A. In response to determining that the gripper arms are not in the inactive state (or determining that the gripper arms are in the active state) at 556, process 500 proceeds to 558 at which a configuration of the gripper arms is adjusted. In some embodiments, 558 corresponds to, or is similar to, 508 of process 500 of FIG. 5A. Process 550 iterates over 554-558 until the system determines that the gripper arms are in the inactive state.

At 560, the system determines to engage an item in a tray or other receptacle (or from a source location). The system determines to engage an item based on a manifest (e.g., an order, a packing slip, etc.).

At 562, the system controls to adjust a position of the suction-based end effector (e.g., the first grasping mechanism). in the inactive state. In some embodiments, 562 corresponds to, or is similar to, 512 of process 500 of FIG. 5A.

At 564, the system uses suction control to grasp the item(s) with the suction-based end effector. In some embodiments, 564 corresponds to, or is similar to, 514 of process 500 of FIG. 5A.

At 566, information is obtained from one or more sensors. In some embodiments, 566 corresponds to, or is similar to, 516 of process 500 of FIG. 5A.

At 568, the system determines whether the item(s) is engaged. In some embodiments, 568 corresponds to, or is similar to, 518 of process 500 of FIG. 5A. In response to determining that the item(s) is not securely grasped (e.g., a suction force between the item and the end effector is less than a threshold suction force, or that the item is not engaged with the item) at 568, process 500 returns to 564 at which the system uses the suction control to adjust/secure engagement/grasping of the item using the suction-based end effector. Process 550 iterates over 564-568 until the system determines that the item(s) is securely grasped by the suction-based end effector.

At 570, a determination is made as to whether one or more other items are to be grasped by the suction-based end effector. For example, the system determines whether the suction-based end effector is to simultaneously move a plurality of items to respective destination locations. In response to determining that one or more other items are to be grasped by the suction-based end effector (e.g., for simultaneous movement/placement) at 570, process 550 returns to 560 and process 550 iterates over 560-570 until the system determines that no further items are to be grasped by the suction-based end effector.

At 572, the item(s) is moved to the destination location and the suction-based end effector is controlled to place the item(s). In some embodiments, 572 corresponds to, or is similar to, 520 of process 500 of FIG. 5A.

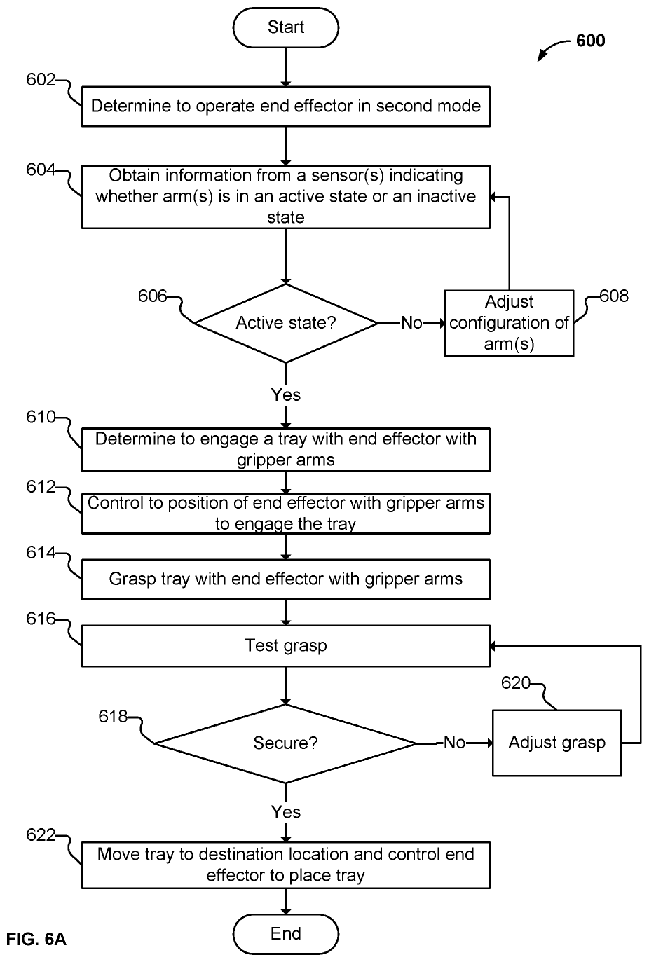

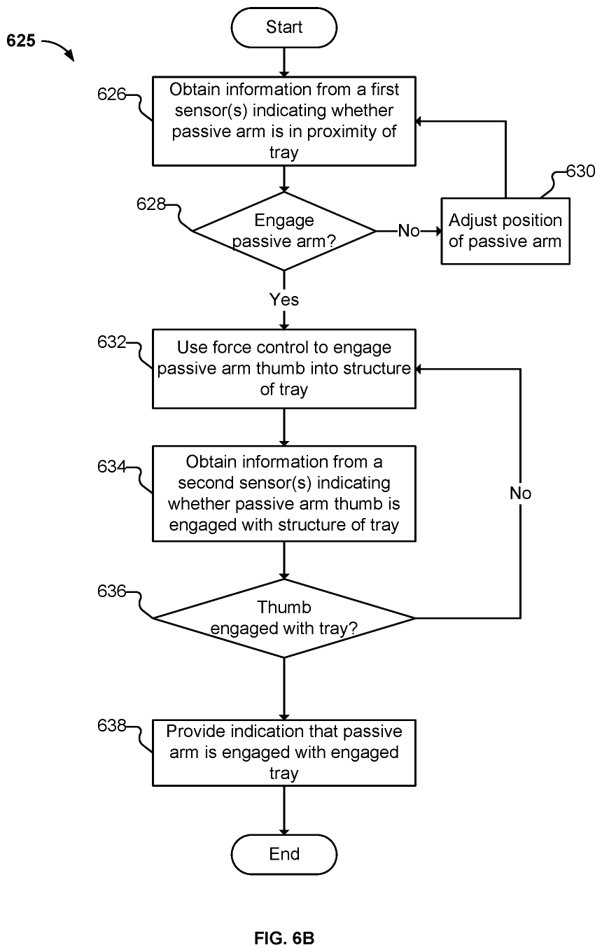

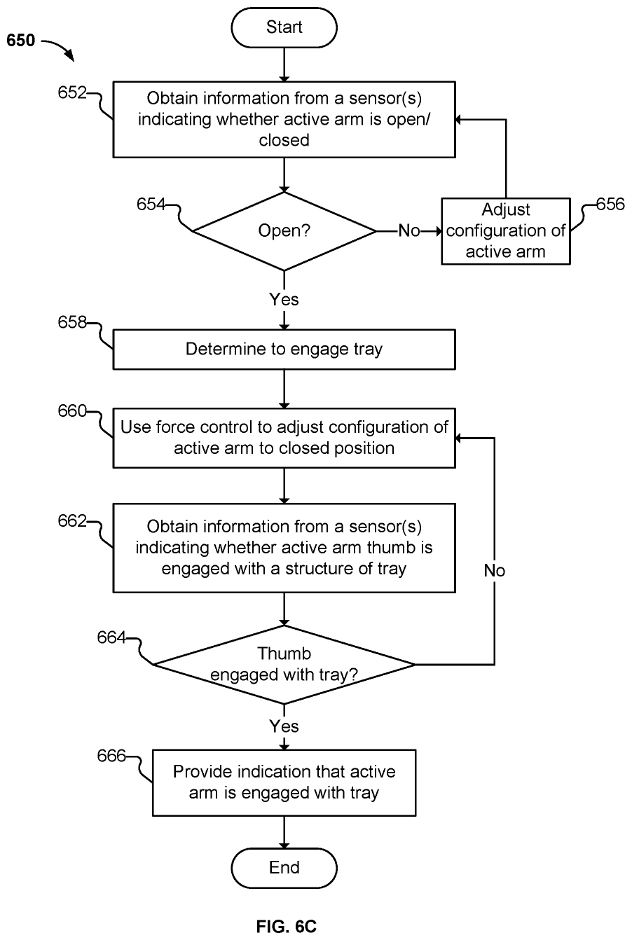

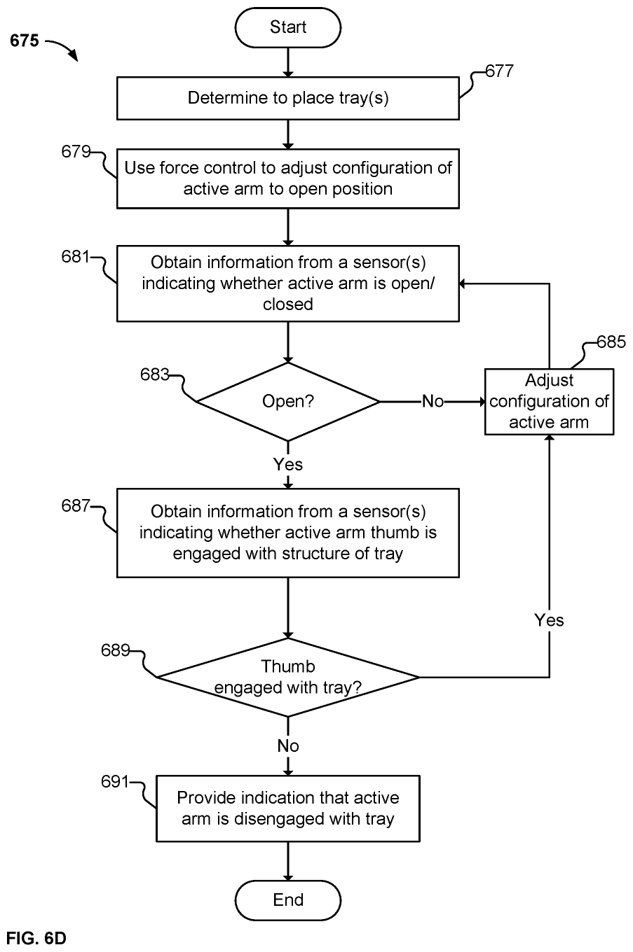

FIG. 6A is a flow diagram of a process for operating an end effector in connection with picking or placing a tray or other receptacle according to various embodiments. In some embodiments, process 600 is implemented in connection with controlling end effector 300 of FIGS. 3A-3B. In some embodiments, process 600 is implemented by system 100 of FIG. 1A, etc.

At 602, a determination is made to operate the end effector (e.g., a multi-mode end effector) in a second mode. In some embodiments, the system determines to operate the multi-mode end effector in the second mode in connection with determining that the object to be grasped is a tray that is to be picked and/or placed on a stack of trays, etc., or otherwise determining that the object is to be grasped with an end effector having gripper arms.

At 604, information is obtained from one or more sensors. The information indicates whether one or more of the gripper arms is in an active state or an inactive state (or some intermediate state between the inactive state or inactive state). In some embodiments, the system uses the information corresponding to a positioning of the gripper arms in connection with controlling the gripper arms (or second grasping mechanism) to transition to the active state or inactive state according to a mode in which the multi-mode end effector is to be operated.

At 606, a determination is made as to whether the gripper arms are positioned in the inactive state. In response to determining that the gripper arms are not in the active state (or determining that the gripper arms are in the inactive state) at 606, process 600 proceeds to 608 at which a configuration of the gripper arms is adjusted. For example, the system controls to move (or continue to move) the gripper arms to the active state (e.g., to the deployed position). In some embodiments, the active state corresponds to the gripper arms are positioned in a threshold deployed state such as within a range of angles between the gripper arms and the lateral member (e.g., the gripper arms are deemed to be in an active state even if the gripper arms are not fully deployed but are within a threshold of deployment of the gripper arms). As an example, with reference to FIG. 3C, the threshold deployed state can correspond to a state according to which side members 304, 306 are within 30 degrees and −30 degrees relative to vector 316. As another example, with reference to FIG. 3C, the threshold deployed state can correspond to a state according to which side members 304, 306 are within 15 degrees and −15 degrees relative to vector 316. Process 600 iterates over 604-608 until the system determines that the gripper arms are in the inactive state.

In response to determining that the gripper arms are in the inactive state at 606, process 600 proceeds to 610 at which the system determines to engage the object (e.g., one or more trays) with the second grasping mechanism (e.g., the gripper arms).

At 612, the system controls to adjust a position of the end effector having gripper arms (e.g., the second grasping mechanism). The system controls to position the end effector having gripper arms to engage the item to be grasped. For example, the system moves the robotic arm and end effector to a position at which the gripper arm(s) of the end effector engages the object (e.g., the tray).

At 614, the system controls the end effector to grasp the tray(s) with the gripper arms (e.g., the end effector comprising gripper arms). The system actuates one or more of the gripper arms to apply a force between the gripper arm and the tray(s) to be grasped. In some embodiments, the end effector having gripper arms is controlled to grasp a plurality of trays (e.g., to simultaneously move the plurality of items to respective destination location). As an example, the system controls an active arm (e.g., active gripper arm that is movable with respect to the lateral member of the multi-mode end effector) to close and to use force control to slot a thumb of the active arm into a grasp hole of the tray(s).

At 616, the system (e.g., the robot) tests its grasp of the tray(s), and if the grasp is determined at 618 to be secure the robot moves the tray to its destination (e.g., process 600 proceeds to 622). If the grasp is determined at 616 not to be secure, the grasp is adjusted at 622 and tested again at 616. For example, the robot sets the tray back down on the source stack, release the tray, and attempt a new grasp. Or, the robot sets the tray at least partly on the source stack and attempt to adjust its grip without fully releasing the tray, e.g., by using force control to try to slot the passive and/or active side thumbs, respectively, more fully into the tray.

At 620, the tray(s) is moved to the destination location and the end effector is controlled to place the tray(s) (e.g., the gripper arm(s) are controlled to disengage/release the tray(s)). In some embodiments, the system controls a robotic arm to move the item to the destination location (or proximity of the destination location) and then controls the end effector to release the tray at the destination location.

According to various embodiments, process 625 and 650 of process 600 is implemented in connection with 612-614 of process 600.

FIG. 6B is a flow diagram of a process for operating an end effector in connection with picking or placing a tray or other receptacle according to various embodiments. In some embodiments, process 625 is implemented in connection with controlling end effector 300 of FIGS. 3A-3B. In some embodiments, process 625 is implemented by system 100 of FIG. 1A, etc. Process 625 is implemented in connection with grasping an item such as a tray.

According to various embodiments, a side member (e.g., passive side member such as side member 304 of end effector 300) comprises one or more sensors. The one or more sensors comprised on the side member are configured to obtain information pertaining to a location of a structure (e.g., a tray) in relation to a position of the end effector (or specifically the passive side member). Examples of information obtained by the one or more sensors include (i) obtain information indicative of when the tray (or end effector relative to the tray) is in a position at which the end effector is controlled to engage at least one side of the end effector (e.g., a passive member or a structure comprised on the passive member) with a hole, a recess, or the a comprised in a side of a tray (e.g., a tray being grasped), (ii) obtain information indicative of when the tray (or end effector relative to the tray) is in a position at which the end effector (e.g., a passive member or a structure comprised on the passive member), etc. The robotic system uses information obtained from the one or more sensors in connection with positioning the passive side member (or the end effector generally). In some embodiments, the robotic system uses the information obtained from the one or more sensors in conjunction with information obtained from a force sensor to control the end effector (e.g., a thumb comprised on passive side member to engage the tray).

In various embodiments, the end effector comprises a first sensor that is configured to obtain information indicative of when the tray is in a position at which the end effector is controlled to engage a passive-side structure (e.g., a thumb disposed on passive side member) with a hole, the recess, or the handle comprised in a structure of the tray. The first sensor is disposed on the passive side member, such as at or near a distal end of the passive side member (e.g., near the bottom or distal end of a fin of the passive side member). As the end effector is moved in proximity to the tray, the robotic system uses information obtained from the first sensor in connection with moving the end effector to engage the tray with the structure on passive-side structure (e.g., a thumb disposed on passive side member). For example, the robotic system uses the information obtained from the first sensor to coarsely position the end effector (e.g., to determine whether the tray is between the side members of the end effector, etc.).

In various embodiments, the end effector comprises a second sensor that is configured to obtain information indicative of when the tray is in a position at which the passive-side structure is engaged with the hole, the recess, or the handle comprised in the structure (e.g., a structure on the side of the tray) The second sensor is disposed on the passive side member, such as in proximity of a structure on the passive side member (e.g., near a thumb of the passive side member or near the top of a fin of the passive side member). As the end effector is moved in proximity to the tray, the robotic system uses information obtained from the second sensor in connection with moving the end effector to engage the tray with the structure on passive-side structure (e.g., a thumb disposed on passive side member). For example, the robotic system uses the information obtained from the second sensor to fine tune a positioning of the end effector.

At 626, information is obtained from a first sensor (s). The information indicates whether a passive arm (passive side member) of the end effector is in proximity of the tray.

At 628, the robotic system determines whether to engage the passive arm. For example, the robotic system uses the information obtained from the first sensor to determine whether to engage the tray with the passive arm. The robotic system determines to engage the tray with the passive arm in response to determining that the plan for moving trays indicates that the tray is to be picked and placed in a destination location, and that the tray is in proximity to the end effector. In some embodiments, the system uses the information obtained from the first sensor to determine whether the tray is between the passive arm and the active arm of the end effector.

In response to determining that the passive arm is not to be engaged (e.g., with the tray) at 628, process 625 proceeds to 630 at which the position of the passive arm is adjusted. The robotic system controls the robotic arm to move the end effector such as closer to the tray. Thereafter, process 625 returns to 626.

In response to determining that the passive arm is to be engaged (e.g., with the tray) at 628, process 625 proceeds to 632 at which the robotic system uses force control to engage the passive arm thumb with the tray. For example, the robotic system uses force control to engage thumb of the passive arm into a structure of the tray (e.g., a hole, recess, handle, etc.).

At 634, information is obtained from a second sensor(s). The information indicates whether the passive arm thumb is engaged with the structure of the tray.

At 636, the robotic system determines whether the thumb of the passive arm is engaged with the tray.

In response to determining that the passive arm thumb is not engaged with the tray at 636, process 625 returns to 632 and 632-636 are repeated. For example, the robotic system further controls to move the end effector to engage the structure of the tray with the passive arm thumb.

In response to determining that the passive arm thumb is engaged with the tray at 636, process 625 proceeds to 638 at which an indication that the passive arm is engaged with the tray. For example, in the case that process 625 is invoked by 612 of process 600, 628 provides an indication to the robotic system (e.g., a process running on the robotic system) that the passive thumb arm is engaged with the tray and that process 600 is to proceed to 606.

FIG. 6C is a flow diagram of a process for operating an end effector in connection with picking or placing a tray or other receptacle according to various embodiments. In some embodiments, process 650 is implemented in connection with controlling end effector 300 of FIGS. 3A-3B. In some embodiments, process 650 is implemented by system 100 of FIG. 1A, etc. Process 650 is implemented in connection with grasping an item such as a tray. Process 650 is implemented in connection with grasping an item such as a tray (or a plurality of trays). For example, process 650 is implemented in connection with 610-614 of process 600.

According to various embodiments, end effector (e.g., the lateral member, the active arm, or both gripper arms) comprises one or more sensors that obtain information pertaining to a position of the active arm or a plurality of gripper arms (e.g., side members 304, 306 of end effector 300). For example, the system uses the information to determine whether the gripper arm(s) are positioned in an active state (e.g., deployed) or an inactive state (e.g., retracted). The system can control the end effector (e.g., the multi-mode end effector) to operate in different modes or to otherwise transition to different states (e.g., the active state, the inactive state, etc.). In some embodiments, the end effector (e.g., the lateral member, the active arm, or both gripper arms) comprises a sensor(s) that detects whether the active arm is in an open position or a closed position. For example, the sensor is a mechanical limit switch that is configured to obtain information indicative of whether the active side member is in an open position or a closed position. As another example, the sensor is a mechanical limit switch that is configured to obtain information indicative of whether the corresponding gripper arm(s) are in a deployed position or in a retracted state (or in an intermediate state between being fully deployed and fully retracted, etc.). In some embodiments, the end effector (e.g., the lateral member or active arm) comprises a sensor(s) that detects an extent to which the gripper arm is in an open position or a closed position (e.g., the sensor determines a particular orientation of the gripper arm or a particular location of the gripper arm between the open position and the closed position, inclusive). As another example, the sensor is a light sensor. The light sensor is configured to obtain information indicative of whether the active side member is in an open position or a closed position. As another example, the sensor is a light sensor. The light sensor is configured to obtain information indicative of whether the corresponding gripper arm(s) are in a deployed position or in a retracted state (or in an intermediate state between being fully deployed and fully retracted, etc.). The light sensor may be further configured to obtain information indicative of an extent to which the active side member is open (e.g., whether the active arm is partially open such as half-way between the open position and the closed position, etc.). The robotic system uses the one or more sensors (e.g., the sensor(s) that obtains information pertaining to a position of the active arm) to control actuation of an actuator(s) that moves the gripper arm(s) to move (e.g., to move the active arm between the closed position and open position).

In some embodiments, end effector (e.g., the active arm of the end effector) comprises one or more sensors that are used to detect whether the active arm (e.g., a thumb of the active arm) is engaged with a tray (e.g., a structure on the tray such as a hole, a recess, or a handle, etc.). For example, the end effector comprises sensor 315a and/or 315b of end effector 300 illustrated in FIG. 3C.

At 652, information indicating whether the active arm is open/closed is obtained from a sensor (e.g., a sensor comprised on the end effector such as at the lateral member or active member). The robotic system uses the sensor to obtain information pertaining to a position of the active arm.

At 654, the robotic system determines whether the active arm is in an open position. For example, the robotic system determines whether the active arm is fully open (e.g., opened to the open position threshold). As another example, the robotic system determines whether the active arm is sufficiently open to grasp a tray (e.g., if an adjacent stack prevents/restricts the robotic system from fully opening the active arm).

In response to determining that the active arm is not in an open position at 654, process 650 proceeds to 656 at which the position of the active arm is adjusted. For example, the position of the active arm is adjusted to permit the end effector to grasp the tray (e.g., to ensure clearance of the tray as the end effector is controlled to grasp the tray). The robotic system controls the robotic arm to move the active arm to further open the active arm, or to fully open the active arm. Thereafter, process 650 returns to 652.

In response to determining that the active arm is in an open position at 654, process 650 proceeds to 658 at which the robotic system determines to engage the tray. For example, the robotic system determines to control the actuator to move the active arm to engage the tray with the active arm (e.g., a structure on the active arm such as an active arm thumb).

At 660, force control is used to adjust the configuration of the active arm to the closed position. In response to determining to engage the tray, the robotic system controls the actuator to move the active arm to the closed position.

At 662, information is obtained from sensor(s), the information indicative of whether the active arm thumb is engaged with a structure of the tray. For example, the robotic system obtains information from sensor 315a and/or 315b of end effector 300 illustrated in FIG. 3C.

At 664, a determination of whether the active arm thumb is engaged with the tray is performed. In some embodiments, the robotic system uses the information obtained from the sensor(s) (e.g., the information indicative of whether the active arm thumb is engaged with a structure of the tray) to determine whether the active arm thumb is engaged with the tray (e.g., whether the active arm thumb is inserted into a hole, recess, or handle of the tray). In some embodiments, the robotic system further obtains information from a force sensor and uses information pertaining to forces acting on end effector in connection with determining whether the active arm thumb is engaged with the tray.

In response to determining that the active arm thumb is not engaged with the tray at 664, process 650 returns to 660 to further adjust the configuration of the active arm. Process 650 iterates through 660, 662, and 664 until the robotic system determines that the active arm thumb is engaged with the tray.

In response to determining that the active arm thumb is not engaged with the tray at 664, process 650 proceeds to 666 at which an indication that the active arm is engaged with the tray is provided. For example, in the case that process 650 is invoked by 612 of process 600, 666 provides an indication to the robotic system (e.g., a process running on the robotic system) that the active thumb arm is engaged with the tray and that process 600 is to proceed to 614.

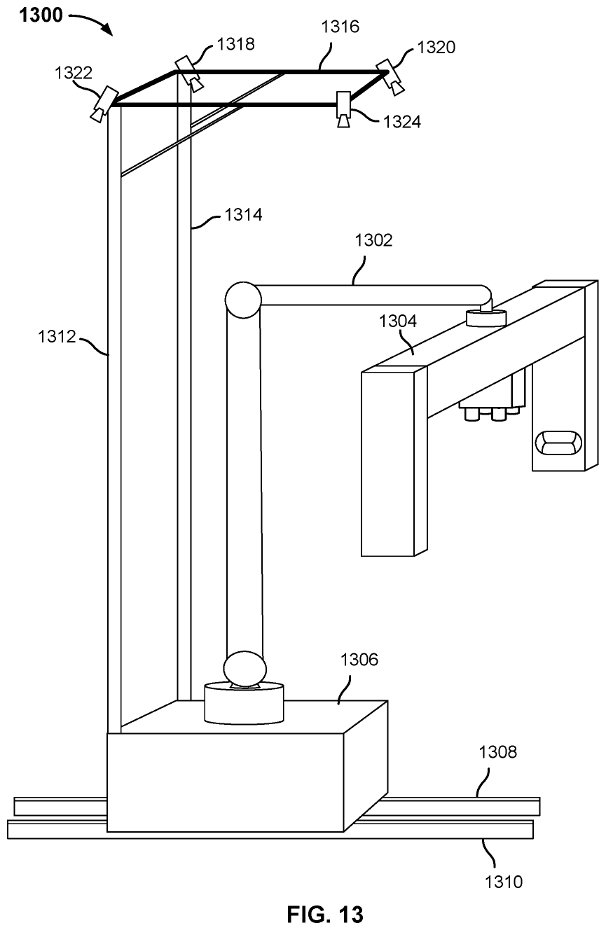

FIG. 6D is a flow diagram of a process for operating an end effector in connection with picking or placing a tray or other receptacle according to various embodiments. In some embodiments, process 675 is implemented by system 100 of FIG. 1A and/or robot 1300 of FIG. 13. Process 675 is implemented in connection with grasping an item such as a tray.

At 677, a determination is made to place one or more trays. The system determines that the one or more trays are to be placed at a destination location. For example, the system determines to generate a stack of trays by placing one or more trays on top of another tray. As another example, the system determines to move a tray at a top of a stack of trays in response to determining that the top tray is empty (e.g., so as to expose items in the tray beneath the top tray).

At 679, force control is used to adjust a configuration of an active arm of the end effector to an open position. For example, the second grasping mechanism of the end effector is robotically positioned in an active state, and the end effector is actuated to move the active arm of the second grasping mechanism in connection with using the second grasping mechanism to place the one or more trays. In some embodiments, the system controls the end effector to move a plurality of gripper arms in connection with releasing a grip on the tray(s).

At 681, information indicating whether the active arm is open or closed is obtained from one or more sensors. In some embodiments, the system determines whether the gripper arm(s) are in an active state or an inactive state.

At 683, a determination is made as to whether the active arm is open (or retracted). For example, the system determines that the whether the gripper arm(s) are in the active state or the inactive state. The system determines whether the active arm is open based at least in part on the information indicating whether the active arm is open or closed that is obtained from one or more sensors.

In response to determining that the active arm is not open at 683, process 675 proceeds to 685 at which a configuration of the active arm is adjusted. The system controls actuation of the end effector (e.g., the active arm) to move the active arm to the open position. Thereafter, process 675 returns to 681 and iterates over 681-685 until the system determines that the active arm is open.

In response to determining that the active arm is open at 683, process 675 proceeds to 687 at which information indicating whether the active arm thumb is engaged with structure of the tray is obtained from one or more sensors.

At 689, a determination is made as to whether the thumb of the active arm is engaged with the tray. In some embodiments, the system determines whether the thumb of the active arm is engaged with the tray based at least in part on the information indicating whether the active arm thumb is engaged with structure of the tray is obtained from the one or more sensors.

At 691, the system provides an indication that the active arm is disengaged with the tray. In some embodiments, the system provides an indication that the gripper arm(s) are disengaged with the tray (e.g., that the tray is released). The system can provide the indication to the process that invoked process 675 (e.g., 620 of process 600).

FIG. 7A is a diagram illustrating an end effector configured in a first mode according to various embodiments. In the example shown, multi-mode end effector 700 is used to be used to pick an item from tray 720. In response to determining to pick an item from tray 720, the system determines to operate multi-mode end effector in a first mode according to which side members 704 and 706 are moved to an inactive state. Moving side members 704 and 706 to the inactive state includes moving side members a sufficient extent to expose suction-based end effector 714 (e.g., to allow for suction-based end effector 714 to engage/grasp the item). In the example shown, side members 704 and 706 are positioned in an inactive state (e.g., a retracted state) according to which side members 704 and 706 are opened about 180 degrees relative to a position at which side members 704 and 706 are in an active state. In various embodiments, side members 704 and 706 are opened greater than 180 degrees (e.g., such that side members 704 and 706 form an acute angle with respect to a top surface of lateral member 702.

FIG. 7B is a diagram illustrating an end effector configured in a first mode according to various embodiments. In the example shown, multi-mode end effector 700 is positioned within proximity of item 724 (e.g., suction-based end effector 714 is engaged with item 724). The system robotically controls a robotic arm to which multi-mode end effector 700 is mounted in order to move suction-based end effector 714 to a source location for item 724. The system robotically controls suction-based end effector 714 to apply a suction force with item 724. For example, the system actuates a suction control of suction-based end effector 714 (or of multi-mode end effector 700) to form a suction between at least one suction cup of suction-based end effector 714 and item 724. The system determines whether item 724 is securely grasped before moving the robotic arm and/or multi-mode end effector 700 to move item 724.

FIG. 7C is a diagram illustrating an end effector configured in a first mode according to various embodiments. In the example shown, multi-mode end effector has picked item 724 from tray 720. In some embodiments, in response to determining that suction-based end effector 714 securely grasps item 724, the system controls the robotic arm to move item 724 to the corresponding destination location.

FIG. 8A is a diagram illustrating a robotically controlled tray and item handling end effector according to various embodiments. In various embodiments, an end effector such as end effector 300 of FIGS. 3A and 3B includes structures as shown in FIG. 8A. In the example shown, end effector 800 includes a lateral member 802 and side members 804, 806 respectively having a thumbs 805,808 configured to be inserted into a handle or other hole or recess on a first side of a tray. As illustrated, side members 804, 806 include a tab or bracket 810, 822mounted on the upper part of the inside side members 804, 806, which in this example is positioned to align with a hole 812 (or set of holes) through lateral member 802. Various other configurations or mountings of side members 804, 806 to lateral member 802 may be implemented. In some embodiments, side thumb 805 and side thumb 808 have different profiles. For example, side thumb 808 have a steeper curvature or profile than the side thumb 805. As another example, side thumb 808 have a larger height than side thumb 805.

According to various embodiments, end effector 300 is a multi-mode end effector. For example, end effector 800 is controlled to operate in a first mode according to which suction-based end effector 830 is used to grasp an object and a second mode according to which second grasping mechanism including side members 804, 806 are used to grasp an object. In the example shown, suction-based end effector 830 is connected to the bottom of lateral member 802. Suction-based end effector 830 includes suction cups 832, 834, 836, and 838. In some embodiments, suction cups 832, 834, 836, and 838 are controlled together (e.g., a single control is used to cause suction for each of suction cups 832, 834, 836, and 838. In some embodiments, suction cups 832, 834, 836, and 838 is controlled individually or in subsets. For example, the system controls suction cups 832, 834 together, and separately control suction cups 836, 838 together. Independent control of at least subsets of suction cups 832, 834, 836, and 838 enables multi-mode end effector 800 to grasp a plurality of items and simultaneously move the items (e.g., in order to place the items at their respective destination locations).

FIG. 8B is a diagram illustrating a robotically controlled tray and item handling end effector according to various embodiments. In various embodiments, an end effector such as end effector 300 of FIGS. 3A-3C includes structures as shown in FIG. 8B. In the example and state shown, end effector 800 of FIG. 8A is shown in an assembled state (and in a deployed position corresponding to the active state). A shoulder bolt 814 (or hinge pin, or similar structure) is shown to be inserted through hole(s) 812 and tab/bracket 810. Side member 804 may be similarly connected to lateral member 802. A pneumatic or hydraulic cylinder (e.g., cylinder 816) is mounted (e.g., by a pivot bracket or other bracket) to an inner surface within lateral member 802.

In various embodiments, cylinder 816 (e.g., a pneumatic cylinder) and end rod 818 comprises a cushioned two-way pneumatic cylinder. Activation of the one or more movable side member (e.g., side members 804, 806) is performed by activating the cylinder 816. The end rod 818 of the cylinder 816 is connected to side members 804, 806. Side member 806, which is rotatably connected to lateral member 802 via a pivot joint formed by inserting shoulder bolt 814 through hole(s) 812 and tab or bracket 810, is pushed/pulled by the pneumatic cylinder to close/open the side member 806, respectively. Side member 804 may be similarly connected to lateral member 802 and similarly controlled to move (e.g., to transition between an active state and an inactive state) The actuation of the cylinder 816 is controlled, in various embodiments, by a four-way two-position single solenoid.

FIG. 8C is a diagram illustrating a robotically controlled tray and item handling end effector according to various embodiments. In the example shown, side members 804 and 806 are transitioned to an inactive state (e.g., a retracted position). Controlling end effector 800 to move side members 804, 806 enables end effector 800 to use suction-based end effector 830.

FIG. 9A is a diagram illustrating a robotically controlled tray and item handling end effector according to various embodiments. In the example shown, tray handling end effector 900 includes a lateral member 902, side member 904, and side member 906. End effector 900 is attached to a robotic arm (not shown) via a force sensor 910 and pivot bracket 912. In the state shown, end effector 900 is operated in a second mode according to which side members 904 and 906 are in an active state and are used to grasp an object, such as tray 914. For example, thumbs (not shown) of side members 904, 906, respectively, may be inserted into corresponding holes (not shown) on either side of tray 914.

In the example shown, end effector 900 further includes guide fins 918 and 920, mounted along the bottom edges of side members 904, 906, respectively. In various embodiments, the guide fins 918, 920 extend along all or a substantial portion of the bottom edge of the side members 904, 906. As shown, each guide fin 918, 920 has a shape that flares outward at the bottom, such that the distance between the respective bottom edges of the guide fins 918, 920 is greater than the width of the tray 914 and the distance between the inner faces of side members 904, 906 when in the closed position, as shown.

FIG. 9B is a diagram illustrating a robotically controlled tray and item handling end effector according to various embodiments. In some embodiments, guide fins 918, 920 are correspondingly rotatably connected to side members 904, 906. As an example, when side members 904, 906 are moved to the inactive state (e.g., to a retracted position), guide fins 918, 920 are controlled to rotate relative to side members 904, 906 to further retract guide fins 918, 920. In the example shown, side members 904, 906 are in an inactive state and guide fins 918, 920 are further retracted (e.g., guide fins 918, 920 are rotated towards the center of lateral member 902 (e.g., from an extended position when side members 904, 906 are in an active state).

Operating end effector 900 in a first mode according to which side members 904, 906 are moved to an inactive state exposes suction-based end effector 930 to grasp an item (e.g., items 922, 924, 926) from tray 914.

FIG. 10A is a diagram illustrating a robotically controlled tray and item handling end effector equipped with a guide fin according to various embodiments. In the example shown, tray handling end effector 1000 includes a lateral member 1002, and side members 1004, 1006. End effector 1000 is attached to a robotic arm (not shown) via a force sensor 1010 and a set of pivot bracket(s) (not shown). In the state shown, end effector 1000 has in its grasp a tray 1014. For example, side thumbs (not shown) of side members 1004 and 1006, respectively, may be inserted into corresponding holes (not shown) on either side of tray 1014. Although the example of end effector 1000 includes only side member 1006 that is movable (e.g., using a pneumatic piston, etc.), both side members 1004 and 1006 may be rotatably connected to lateral member 1002.

In the example shown, end effector 1000 further includes guide fins 1018 and 1020, mounted along the bottom edges of side members 1004, 1006, respectively. In various embodiments, the guide fins 1018, 1020 extend along all or a substantial portion of the bottom edge of the side members 1004, 1006. As shown, each guide fin 1018, 1020 has a shape that flares outward at the bottom, such that the distance between the respective bottom edges of the guide fins 1018, 1020 is greater than the width of the tray 1014 and the distance between the inner faces of the passive and side members 1004, 1006 when in the closed position, as shown.

As shown in FIG. 10A, the end effector 1000 is being used to position the tray 1014 over tray 1016, e.g., to place the tray 1014 onto the tray 1016. For example, the tray 1016 may be the topmost tray on a destinate stack to which the tray 1014 is to be added.

In some embodiments, end effector 1000 comprises one or more vehicle gripper modules 1021a or 1021b on side members 1004, 1006, or guide fins 1018, 1020. The vehicle gripper modules 1021a or 1021b can comprise inner surfaces (e.g., surfaces that engage a tray or vehicle such as a dolly) that have a relatively higher friction than inner surfaces of side members 1004, 1006, or guide fins 1018, 1020. The one or more vehicle gripper modules 1021a or 1021b can be shaped or configured to stably grasp a vehicle (e.g., dolly) when the end effector is controlled to engage the one or more vehicle gripper modules 1021a or 1021b with such a vehicle.

In the example shown, end effector 1000 comprises a suction-based end effector 1030. For example, end effector 1000 is be a multi-mode end effector that is selectively operated in a plurality of modes (e.g., a first mode in which suction-based end effector 1030 is used to grasp an object, a second mode in which side members 1004, 1006 are used to grasp an object, and/or a third mode in which end effector 1000 is controlled to pull/push a tray, a cart, or other object).

FIG. 10B is a diagram illustrating a robotically controlled tray and item handling end effector equipped with a guide fin according to various embodiments. In the example and state shown in FIG. 10B, the guide fins 1018, 1020have facilitated the use of force control to align and place the tray 1014 onto tray 1016, as shown. In various embodiments, the guide fins 1018, 1020 have a certain degree of compliance that facilitates the placing of trays. Guide fins 1018, 1020 are designed in various embodiments to have flexure properties to increase operation speed and tolerances as well as accuracy.

In various embodiments, tray place episodes by a single robot tray gripping robot as disclosed herein are smooth, gentle, and precise and tolerant to uncertainty and wobbling. In various embodiments, a place episode includes one or more of:
Using force control to go down from a hover position above the destination stack (e.g., as shown in FIG. 10A) and making contact with the guide fins (e.g., one or both of guide fins 1018,1020) first.
The guide fins 1018,1020 help to guide the tray being placed into a position more aligned with the tray on which the tray being placed is to be place, and the guide fins 1018,1020 also provide feedback signals via the load cell (e.g., force sensor 1010) to adjust the position of the incoming tray on top of the stack.
Using force control, the robot makes steady contact with the destination stack and gently inserts the tray (e.g., 1014) onto it.

FIG. 10C is a diagram illustrating a robotically controlled tray and item handling end effector equipped with a guide fin according to various embodiments. FIG. 10D is a diagram illustrating a robotically controlled tray and item handling end effector equipped with a guide fin according to various embodiments. In the examples illustrated in FIGS. 10C and 10D, end effector 1000 further comprises sensor(s) 1022 and/or sensor(s) 1024. The robotic system uses sensor(s) 1022 and/or sensor(s) 1024 in connection with guiding end effector 1000 to grasp tray 1014, such as to control end effector 1000 to engage tray 1014 with a structure on one or both of side members 1004, 1006.

The robotic system uses sensor(s) 1024 to detect whether tray 1014 is in proximity to end effector 1000 such as in a manner that robotic system can finely control movement of end effector to engage the tray with the structure on side member 1004 (e.g., a thumb on side member 1004). In some embodiments, sensor(s) 1024 obtain information indicative of when tray 1014 is in a position at which end effector 1000 is controlled to engage the passive-side structure with the hole, the recess, or the handle comprised in the tray 1014.

The robotic system uses sensor(s) 1022 to detect whether tray 1014 is engaged by side member 1004 (e.g., by the structure on side member 1004, such as a thumb). In some embodiments, sensor(s) 1024 obtain information indicative of when tray 1014 is in a position at which the passive-side structure is engaged with the hole, the recess, or the handle comprised in the tray 1014. As illustrated in FIG. 10D, the system determines that the robotic system determines that the tray 1014 is in a position at which the passive-side structure is engaged with the hole, the recess, or the handle comprised in the tray 1014 when (i) information obtained from sensor(s) indicates that a structure is adjacent the sensor (e.g., light is reflected back to sensor(s) 1022), (ii) information obtained by sensor(s) 1024 indicates that no structure is proximate to sensor(s) 1022 (e.g., no light is reflected back to sensor(s) 1024).

In some embodiments, the robotic system uses information obtained by sensor(s) 1022 and/or 1024 in connection with determining whether to control the actuator to move one or both side members 1004, 1006 (e.g., to engage tray 1014 with a thumb(s) of side members, 1004 1006) to grasp tray 1014.

End effector 1000 includes one or more rigid structures on one or more side members (e.g., gripper arms), such as rigid structures 1040a, 1040b of side members 1004, 1006. In some embodiments, the system controls a robot and/or end effector 1000 to use rigid structure 1040a and/or 1040b to move a dolly (or other cart, etc.), to push or pull a tray, etc. As an example, end effector 1000 includes rigid structure 1040 in addition to, or as an alternative to vehicle gripper modules 1021a or 1021b.

Although the examples illustrated in FIGS. 10A-10D are provided in the context of grasping trays, side members 1004 and 1006 are used to grab various other objects. For examples, side members 1004 and 1006 are used as gripper arms (e.g., the gripper arms are used similar to a pincer to pinch items). The gripper arms are used to pick up boxes or other items.

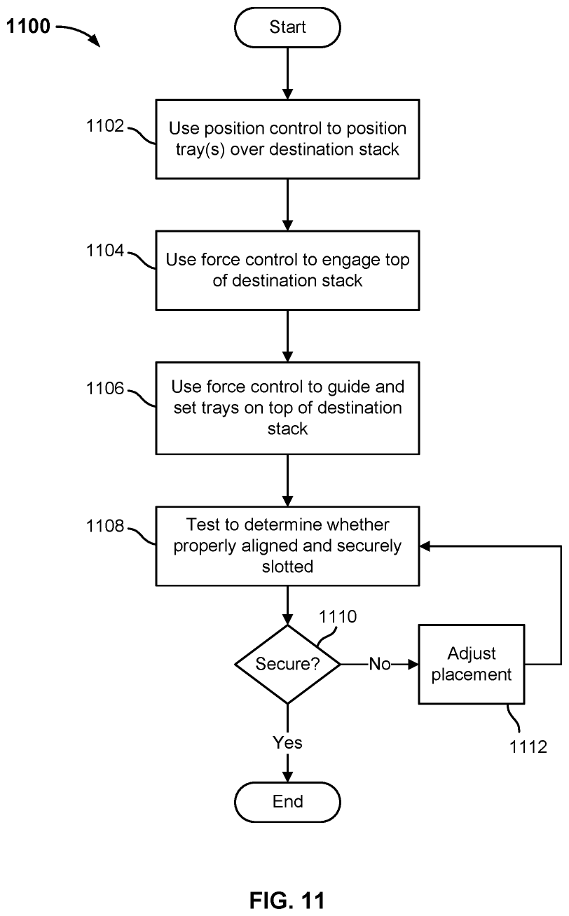

FIG. 11 is a flow diagram of an automated process to place one or more trays on a stack according to various embodiments. In various embodiments, the process 1100 of FIG. 11 is performed by a control computer, such as control computer 128 of FIG. 1A, configured to control one or more single robot tray handling robots, as disclosed herein. In the example shown, at 1102 position control is used to position one or more trays to be placed, e.g., on the top of a destination stack. For example, 3D camera and/or other image data are used to determine a position and orientation of the destination stack, and the robot are moved (e.g., along a rail) into a position near the destination stack and then the robotic arm maneuvered to position the tray above the destination stack. At 1104, force control is used to engage the top of the destination stack. For example, referring to the example shown in FIGS. 10A and 10B, the tray 1014 are lowered until the bottom edge of one or both of the guide fins 1018, 1020 just touches the tray 1016 at the top of the destination stack. At 1106, force control is used to guide and set the tray (e.g., tray 1014) onto the top of the destination stack (e.g., top of tray 1016). At 1108, the robot tests to determine whether the tray being placed is fully and properly aligned with and securely slotted into the top of the topmost tray of the destination stack.

In various embodiments, the slotting episode (e.g., 1108) serves to ensure the stability of the tray on top of the stack and its proper insertion. After the adjustment in the z axis (up/down) and the y axis (axis along rail along with the trays slot, e.g., the axis into and out of the page as shown in FIGS. 9A and 9B) the robot executes a routing to ensure that the third direction (x axis, side to side as shown in FIGS. 9A and 9B) is also stable. In various embodiments, a slotting episode includes:
Gently pull the tray back on top of the slot as it was placed in an offset position forward with respect to the stack.
Series of force motions to get the tray unstuck and moving smoothly; if force feedback indicates the tray is over-slotted, corrective action is performed to reverse the slot. For example, if the system fails to find a notch at the back of the tray and there is an equivalent notch at the front of the tray, the system tries to “slot” against it by reversing the direction of slotting motion.
The quality of the slot is verified by moving the tray forward and backward and analyzing the resulting force signals. In various embodiments, the robot learns and/or is manually trained to recognize force signals indicative of secure (or not secure) slotting.

If the tray is determined to have been securely slotted (1110), the robot releases the tray (e.g., opens one or more of the side members and withdraws the thumb(s) from the hole(s) into which it was inserted) and the process ends. If not (1110), at 1112 the placement is adjusted and tested again at 1108. If after a configured number of attempts the tray cannot be verified as having been placed securely, in various embodiments, the system prompts a human worker to assist it, e.g., by teleoperation or manual work.

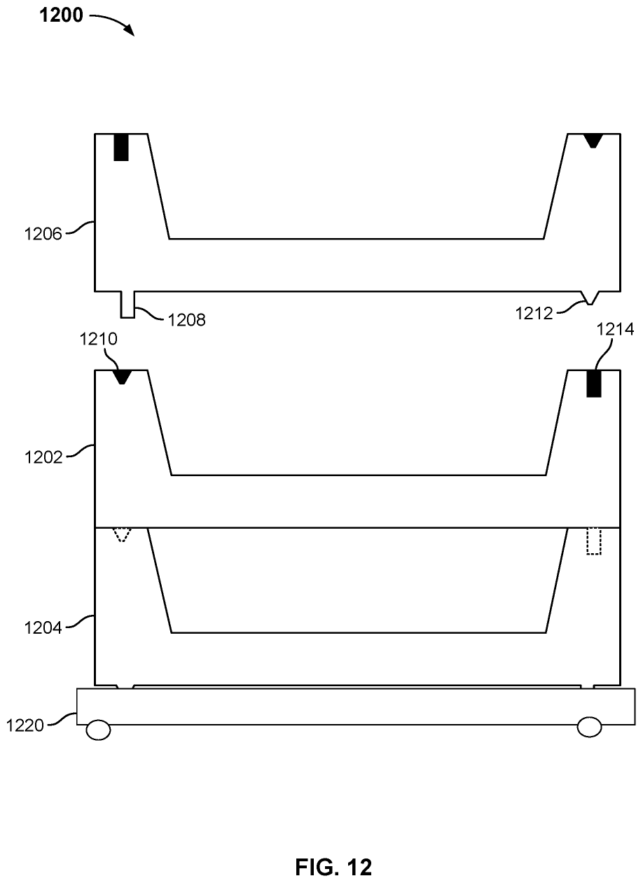

FIG. 12 is a diagram illustrating an example of a stack of trays configured to be stacked in a specific tray orientation. In the example shown, destination stack 1200 includes a tray 1202 stacked on top of a tray 1204. A tray 1206 is to be added to the top of the stack 1200. The trays 1202, 1204, 1206 each include a pair of dissimilarly shaped recesses at the top of the tray, e.g., recesses 1210 and 1214 on the top of tray 1202, one a on first side and the other on the opposite side, and corresponding protrusions at the bottom of the tray, e.g., protrusions 1208 and 1212 at the bottom of tray 1206. As shown in FIG. 12, the protrusion 1208 is of a size and shape to fit into recess 1214, while protrusion 1212 is of a size and shape to fit into recess 1210. However, as shown tray 1206 is flipped around such that the protrusion 1208 is over recess 1210, which it does not match, while protrusion 1212 is positioned over recess 1214, which it also does not match.

In various embodiments, a tray handling robot system as disclosed herein learns and/or is trained to recognize a force sensor reading and/or profile associated with a misalignment as shown in FIG. 12. The system detects, e.g., upon attempting to place the tray 1206 onto tray 1202, that the tray 1206 is not slotted securely onto tray 1202 in a way associated with the tray 1206 being flipped around into a reverse position, as shown in FIG. 12. In various embodiments, in response to detecting an incorrect orientation as shown in FIG. 12, the system lifts the tray (e.g., 1206) up, rotates the tray 180 degrees around the z (up/down) axis, and renews its attempt to place the tray on top of the destination stack.

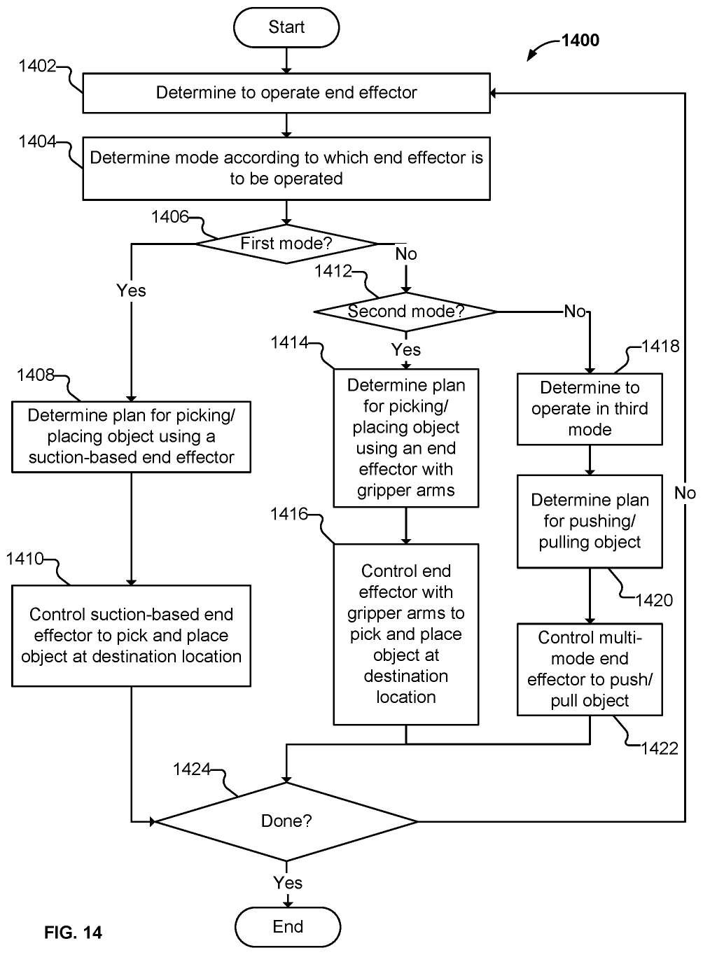

FIG. 13 is a diagram illustrating an embodiment of a tray handling robot. Robot 1300 implements (or be used to implement) process 400 of FIG. 4, process 500 of FIG. 5A, process 550 of FIG. 5B, process 600 of FIG. 6A, process 625 of FIG. 6B, process 650 of FIG. 6C, process 675 of FIG. 6D, and/or process 1400 of FIG. 14.

In various embodiments, one or more robots such as robot 1300 of FIG. 13 may be included in a robotic tray handling system as disclosed herein, e.g., robotic arms 112, 114 in FIGS. 1A and 1B. In the example shown, robot 1300 includes a robotic arm 1302 and tray handling end effector mounted on a chassis 1306 (e.g., a carriage, etc.) configured to be moved under robotic control along rails 1308 and 1310. A superstructure comprising vertical supports 1312 and 1314 and upper frame 1316 provides mounting locations for 3D cameras 1318, 1320, 1322, and 1324. In various embodiments, one or more 3D cameras are placed near the base of the robot.

In various embodiments, robot 1300 is deployed in a tray handling system as shown in FIGS. 1A and 1B. Source tray stacks are provided on one side of rails 1308 and 1310 (e.g., beyond rail 1308 as shown) and destination tray stacks are built on an opposite side of rails 1308 and 1310 (e.g., on the side of rail 1310 nearer the viewer, as shown). Pairs of cameras on the source tray stack side (e.g., 1318, 1320) and destination tray stack side (e.g., 1322, 1324) are used to provide a view of relevant portions of the workspace in the vicinity in which the robot 1300 is located and working.

In various embodiments, the image data is used to do one or more of the following: avoid collisions with other robots, tray stacks, and other items present in the workspace; plan trajectories; and position the end effector 1304 and/or a tray in the grasp of end effector 1304 in at least an initial position under position control. End effector 1304 is a multi-mode end effector comprising a first grasping mechanism (e.g., a suction-based end effector) and a second grasping mechanism (e.g., an end effector having gripper arms). End effector is robotically controlled to operate in one of a plurality of different operating modes, such as a first mode in which an object is grasped using a suction-based end effector, a second mode in which an object is grasped using an end effector having gripper arms, a third mode in which end effector 1304 is used to push or pull an object such as a stack of trays, a cart, a dolly, etc. Various other modes may be implemented.

In some embodiments, the cameras 1318, 1320, 1322, and 1324 are included in a vision system used to control of a robotic tray handling system as disclosed herein. In some embodiments, the vision system is designed to self-calibrate. The robot uses a marker that is installed on one of its joints and exposes the marker to the cameras in the system, e.g., cameras 1318, 1320, 1322, and 1324, which recognize the marker and perform a pose estimation to understand their own pose in world coordinates. The robot plans its motion using collision avoidance to get the marker into a position close to the cameras to get a high-quality calibration.

In some embodiments, a onetime manual process follows the automatic calibration to further ensure the quality of the process. A point cloud is overlaid on top of the simulated graphics of the system and a human operator performs the matching or the rendered graphics of the robot plus environment in a simulator to the point cloud as seen by the camera mounted on the robot. Further verification procedures are also in place to verify perceived depth of objects of known heights in the world frame (coordinates).

In some embodiments, a system as disclosed herein self-calibrates its own dimensions. The robot moves up and down the rail to find the pick and place locations and uses force control to find the coordinates of the input-output slots. It dynamically performs an update. For example, in some embodiments, the system uses specially designed calibration motions (including force control) to find the exact locations of each of the input and the output facings (where stacks of trays exist) referred to as the “layout”, and updates layout values internally that many times reveal variations such as uneven ground surfaces, peripheral installation misalignments. The robot dynamically performs these updates through its lifespan, in various embodiments.

In some embodiments, the vision system approximates the pose of the target tray or the target destination stack to check the robot goal motions. A vision system scheduler guarantees simultaneous checks when it is possible to and both input and output targets are in the field of view.

FIG. 14 is a flow diagram of a process for selecting a mode according to which an end effector is to be operated, and operating the end effector in a selected mode according to various embodiments. In some embodiments, process 1400 is implemented by system 100 of FIG. 1A and/or robot 1300 of FIG. 13.

At 1402, a determination is made to operate the end effector (e.g., a multi-mode end effector) to pick/place an object. In some embodiments, an object may be a tray, a receptacle, a tote, a box, an item (e.g., an item that can be included in a tray), etc.

At 1404, a mode according to which the end effector is to be operated is determined. The system selects, from a plurality of modes, the mode according to which the end effector is to be operated. In some embodiments, the system determines whether to operate the end effector in (i) a first mode according to which a first grasping mechanism (e.g., a suction-based end effector) is used to grasp the object, (ii) a second mode according to which a second grasping mechanism (e.g., an end effector comprising a plurality of gripper arms) is used to grasp the object, and (iii) a third mode according to which a structure of the multi-mode end effector is used to push or pull an object such as a stack of trays, a cart, a dolly, a tray, an item in a tray, etc.

At 1406, a determination is made as to whether the mode according to which the end effector is to be operated is a first mode. In response to determining that the mode according to which the end effector is to be operated is the first mode at 1406, process 1400 proceeds to 1408. Conversely, in response to determining that the end effector is not to be operated in the first mode at 1406, process 1400 proceeds to 1412.

At 1408, a plan for picking/placing an object using a suction-based end effector is determined. In response to determining to operate the end effector in the first mode, the system determines a plan (or strategy) for grasping the object such as an item comprised in a tray or other receptacle and for placing the object at a destination location (e.g., a tray, a conveyor, a shelf, etc.). In some embodiments, in response to determining to operate the end effector in the first mode, the system controls the end effector to transition the second grasping mechanism to an inactive state (e.g., in which the gripper arms are moved to a retracted position). The plan determined for grasping the object can include an operation to transition the second grasping mechanism to the inactive state.

At 1410, the suction-based end effector is controlled to pick and place an object at a destination location. The system controls the suction-based end effector to actuate a suction mechanism to apply a suction force between a suction cup of the suction-based end effector and the object to be grasped. The system controls the suction mechanism based at least in part on feedback received by a sensor that detects a suction force (or other attribute of the suction between the suction cup and the object). In some embodiments, controlling the suction-based end effector to pick and place the object comprises controlling a robotic arm to which a multi-mode end effector is mounted to use a suction-based end effector thereof to pick and place the object.

At 1412, a determination is made as to whether the mode according to which the end effector is to be operated is a second mode. In response to determining that the mode according to which the end effector is to be operated is the second mode at 1412, process 1400 proceeds to 1414. Conversely, in response to determining that the end effector is not to be operated in the first mode at 1412, process 1400 proceeds to 1418.

At 1414, a plan for picking/placing the object using an end effector comprising gripper arms is determined. In response to determining to operate the end effector in the second mode, the system determines a plan (or strategy) for grasping the object such as a tray (e.g., a tray comprised in a stack of trays, etc.). In some embodiments, in response to determining to operate the end effector in the second mode, the system controls the end effector to transition the second grasping mechanism to an active state (e.g., in which the gripper arms are moved to a deployed position). The plan determined for grasping the object can include an operation to transition the second grasping mechanism to the active state.

At 1416, the end effector comprising gripper arms is controlled to pick and place an object at a destination location. The system controls the end effector comprising gripper arms (e.g., the second grasping mechanism) to actuate movement of one or more of the gripper arms to grip the object (e.g., the tray) to be grasped. For example, the system controls to move an active side member to engage the object. The system controls the end effector comprising gripper arms based at least in part on feedback received by a sensor that detects positioning of one or more gripper arms (or thumbs of such arms) relative to the object to be grasped. In some embodiments, controlling the end effector comprising gripper arms to pick and place the object comprises controlling a robotic arm to which a multi-mode end effector is mounted to use the gripper arms thereof to grasp, and pick/place the object.

At 1418, a determination is made to operate the end effector in a third mode. As an example, the system determines to operate the end effector in response to determining that an item to be grasped is best suited for a structure of the end-effector rather than the suction-based end effector. As another example, the system determines to operate the end effector in the third mode in response to determining that an item is to be slightly nudged or moved, or that a stack of trays or a cart/dolly is to be moved/pushed.

At 1420, a plan for pushing and/or pulling an object is determined. The object may be a stack of tray, a cart, a dolly, an item in the workspace, etc. In response to determining to operate the end effector in the third mode, the system determines a plan (or strategy) for moving the object based on nudging or pushing/pulling the object using a part of the end effector such as a rigid structure, a hook, etc. The plan determined for grasping the object can include an operation to transition the second grasping mechanism to the active state.

At 1422, the end effector is controlled to push/pull the object. In some embodiments, the system controls the robotic arm to which the multi-mode end effector is mounted to engage the item using a part of the multi-mode end effector (e.g., a rigid structure, a hook, etc.) and controls the robotic arm to push/pull the object using the multi-mode end effector.

At 1424, a determination is made as to whether process 1400 is complete. In some embodiments, process 1400 is determined to be complete in response to a determination that no further objects, trays, or carts are to be moved (e.g., picked or placed), a tote or other receptacle corresponding to a manifest (e.g., an order) is assembled/packed, a user has exited the system, an administrator indicates that process 1400 is to be paused or stopped, etc. In response to a determination that process 1400 is complete, process 1400 ends. In response to a determination that process 1400 is not complete, process 1400 returns to 1402.

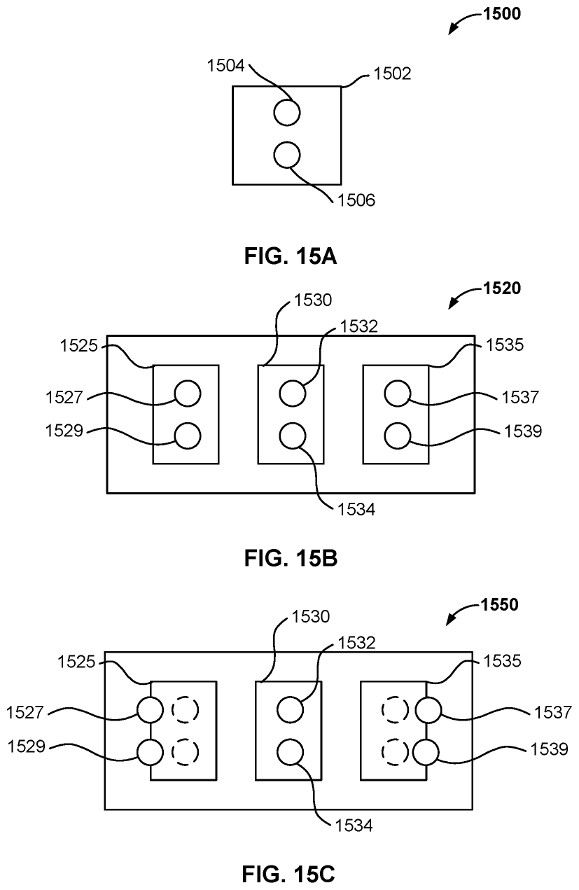

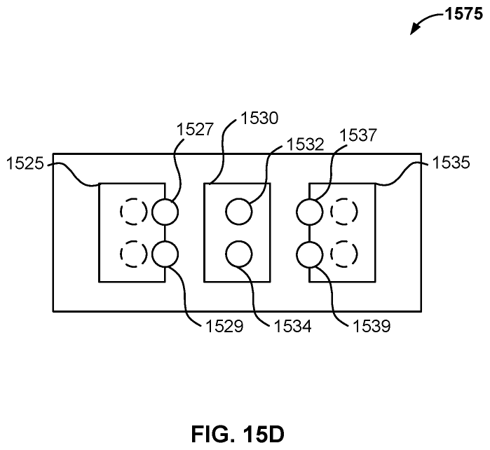

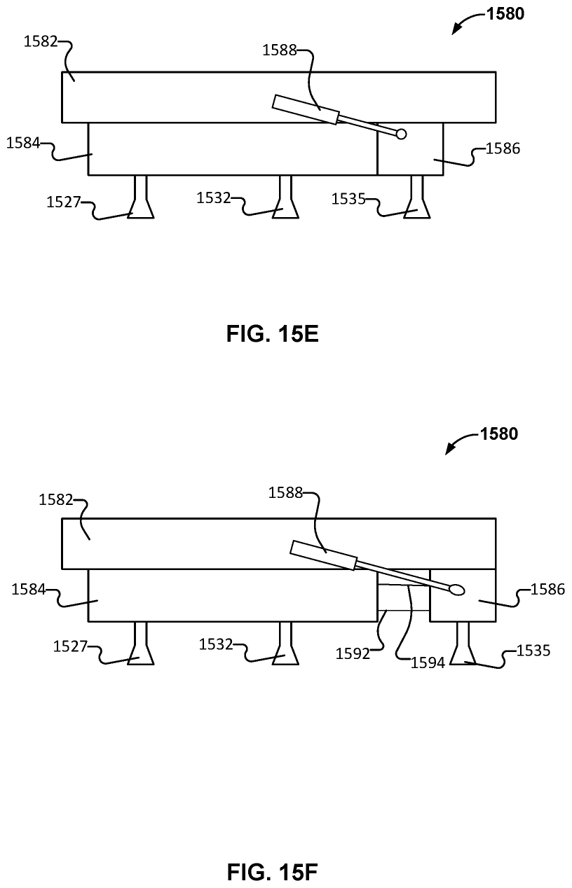

FIG. 15A is a diagram illustrating a bottom view of a suction-based end effector according to various embodiments. In some embodiments, system 100 of FIG. 1 implements end effector 1500. According to various embodiments, end effector 1500 is a suction-based end effector. End effector 1500 may be comprised in a multi-mode end effector. For example, end effector 1500 corresponds to a first grasping mechanism of the multi-mode end effector.

In the example illustrated in FIG. 15A, end effector 1510 having a square face 1502 (e.g., a square base) comprises a plurality of suction cups and at least a first subset of the plurality of suction cups is different from a second subset of the plurality of suctions cups. For example, suction cup 1504 is larger than suction cup 1506. As another example, suction cup 1504 has a diameter that is larger than diameter of another suction cup on end effector 1500, such as suction cup 1506.

An actuation mechanism (not shown) operatively connected to end effector 1500 actuates a suction for one or more of the suction cups of end effector 1500. In some embodiments, an actuation mechanism actuates a first suction cup independent from actuation of a second suction cup. In some embodiments, a suction cup is actuated according to a set of suction cups to which the suction cup belongs. The actuation mechanism actuates one or more of the suction cups on the end effector 1500 based at least in part on a plan (e.g., a grasping strategy included in a plan for a singulation operation, a plan for a kitting operation, etc.).

FIG. 15B is a diagram illustrating a bottom view of a suction-based end effector according to various embodiments. In some embodiments, system 100 of FIG. 1 implements end effector 1520. In some embodiments, system 100 of FIG. 1 implements end effector 1520. According to various embodiments, end effector 1520 is a suction-based end effector. End effector 1520 is comprised in a multi-mode end effector. For example, end effector 1520 corresponds to a first grasping mechanism of the multi-mode end effector.

In some embodiments, end effector 1520 comprises one or more movable suction cups. Positioning of the movable suction cups is controlled based on an item to be grasped by end effector 1520 or based on a plurality of items to be grasped. For example, positioning of the movable suction cups is controlled based on a plan for grasping one or more items using end effector 1520. A suction cup is moved relative to the face of end effector 1520 to widen the distance between at least two suction cups on end effector 1520, such as in connection with enabling end effector 1520 to grasp two distinct items to allow for simultaneous grasping/moving of the items. A suction cup may also be moved relative to the face of end effector 1520 to shorten a distance between at least two suction cups on end effector 1520, such as in connection with enabling end effector 1520 to grasp a single item using the two suction cups.

In the example shown, end effector 1520 comprises three sets of suction cups: first set 1525, second set 1530, and third set 1535. First set 1525 comprises suction cups 1527, 1529; second set 1530 comprises suction cups 1532, 1534; and third set 1535 comprises suction cups 1537, 1539.

In some embodiments, at least two of the first set 1525, second set 1530, and third set 1535 are controlled independent of one another (e.g., suction can be independently applied to different sets of the three sets of suction cups). In some embodiments, at least two of the first set 1525, second set 1530, and third set 1535 are controlled together (e.g., a collective control is used to apply suction across the suction cups of such at least two sets). In some embodiments, suction for any one set of the three sets of suction cups are independently controlled for the various suction cups in such set or may be controlled on a subset-by-subset basis. For example, with respect to first set 1525, suction cup 1527 is controlled independent from suction cup 1529.

The end effector 1520 is controlled to move one or more suction cups among the various sets of suction cups.

FIG. 15C is a diagram illustrating a bottom view of a suction-based end effector according to various embodiments. In some embodiments, system 100 of FIG. 1 implements end effector 1550. In some embodiments, system 100 of FIG. 1 implements end effector 1550. According to various embodiments, end effector 1550 is a suction-based end effector. End effector 1550 is comprised in a multi-mode end effector. For example, end effector 1550 corresponds to a first grasping mechanism of the multi-mode end effector.

In the example shown in contrast to end effector 1520 of FIG. 15B, the suction cups of first set 1525 and the suction cups of third set 1535 are moved. For example, end effector 1550 is controlled to shift suction cups 1527, 1529, 1537, and 1539 towards an outside circumference of the face for end effector 1550. In some embodiments, end effector 1550 is controlled to move (e.g., shift) a subset of the suction cups on end effector 1550. For example, end effector 1550 is controlled to shift suction cup 1527, suction cup 1529, or both, and to maintain suction cups 1532, 1534, 1537, and 1539 in their normal positions.

As illustrated in FIG. 15C, shifting of suction cups 1527 and 1529 in first set 1525 increases a distance between suction cups 1527 and 1532, and a distance between suction cups 1529 and 1534. End effector 1550 may thus be controlled to widen its grasp (or grasping range) to facilitate grasping a larger item (e.g., to better position the suction cups across a surface of a larger item) or to enable end effector 1550 to simultaneously grasp a plurality of items (e.g., a first item grasped with first set 1525, and a second item grasped with second set 1530).

FIG. 15D is a diagram illustrating a bottom view of a suction-based end effector according to various embodiments. In some embodiments, system 100 of FIG. 1 implements end effector 1575. In some embodiments, system 100 of FIG. 1 implements end effector 1575. In some embodiments, system 100 of FIG. 1 implements end effector 1575. According to various embodiments, end effector 1575is a suction-based end effector. End effector 1575 is comprised in a multi-mode end effector. For example, end effector 1575 corresponds to a first grasping mechanism of the multi-mode end effector.

In the example shown in contrast to end effector 1520 of FIG. 15B, the suction cups of first set 1525 and the suction cups of third set 1535 are moved. For example, end effector 1575is controlled to shift suction cups 1527, 1529, 1537, and 1539 towards an inner part of end effector 1575 (e.g., the suction cups are moved closer to second set 1530). In some embodiments, end effector 1575 is controlled to move (e.g., shift) a subset of the suction cups on end effector 1575. For example, end effector 1575 is controlled to shift suction cup 1527, suction cup 1529, or both, and to maintain suction cups 1532, 1534, 1537, and 1539 in their normal positions.

As illustrated in FIG. 15D, shifting of suction cups 1527 and 1529 in first set 1525 decreases a distance between suction cups 1527 and 1532, and a distance between suction cups 1529 and 1534. End effector 1575 may thus be controlled to shorten its grasp (or grasping range) to facilitate grasping a smaller item (e.g., to better position the suction cups across a surface of a smaller item).

In some embodiments, a first set of one or more suction cups are moved to increase a distance between such suction cups and the center of the suction-based end effector while a second set of one or more suction cups are moved to decrease a distance between such suction cups and the center of suction-based end effector. With reference to FIGS. 15C and 15D, first set 1525 are positioned (e.g., moved outwards) as illustrated in FIG. 15C while third set 1535 is positioned (e.g., moved inwards) as illustrated in FIG. 15D.

FIGS. 15E and 15F are diagrams illustrating a side view of a suction-based end effector according to various embodiments. In some embodiments, suction-based end effector is implemented as a first grasping mechanism for a multi-mode end effector, such as multi-mode end effector 300 of FIGS. 3A-3C, multi-mode end effector 800 of FIG. 8A-8C, multi-mode end effector 900 of FIGS. 9A-9B, and multi-mode end effector 1000 of FIGS. 10A-10D. For example, the multi-mode end effector uses the suction-based end effector to grasp object(s) in connection with operating in a first mode.

In the example shown, suction-based end effector 1580 comprises a plurality of suction cups 1527, 1532, 1535. In some embodiments, suction-based end effector 1580 is robotically controlled to change a configuration or relative positioning of at least a subset of the plurality of suction cups 1527, 1532, 1535. For example, suction-based end effector 1580 comprises actuation mechanism 1588 that is configured to change the position/configuration of suction cup 1535. The plurality of suction cups 1527, 1532, 1535 are mounted on mounting plates 1584, 1586 and in response to being actuated, such as by a control signal sent by a control computer, actuation mechanism 1588 is actuated to move mounting plate 1586 relative to mounting plate 1584, which in turn changes the configuration/position of a subset of suction cups (e.g., suction cup 1586) relative to another subset of suction cups (e.g., suction cups 1527, 1532). As illustrated in FIG. 15F, suction-based end effector 1580 comprises sliders 1592, 1594 along which mounting plate 1586 (and in turn suction cup 1535) traverses. Sliders 1592, 1594 may be pistons or channels that provide support to mounting plate 1586 and allow traversal by mounting plate 1586 when actuation mechanism 1588 is actuated. In some embodiments, sliders 1592, 1594 are pneumatic sliders that are controlled to change the configuration/position of a subset of suction cups (e.g., suction cup 1586) relative to another subset of suction cups (e.g., suction cups 1527, 1532), such as by causing mounting plate 1586 to move relative to mounting plate 1584.

Although FIGS. 15E and 15F illustrate actuation mechanism 1588 being a pneumatic piston, various other actuation mechanisms may be implemented. Examples of other actuation mechanisms include rack and pinion configurations, motors, etc.

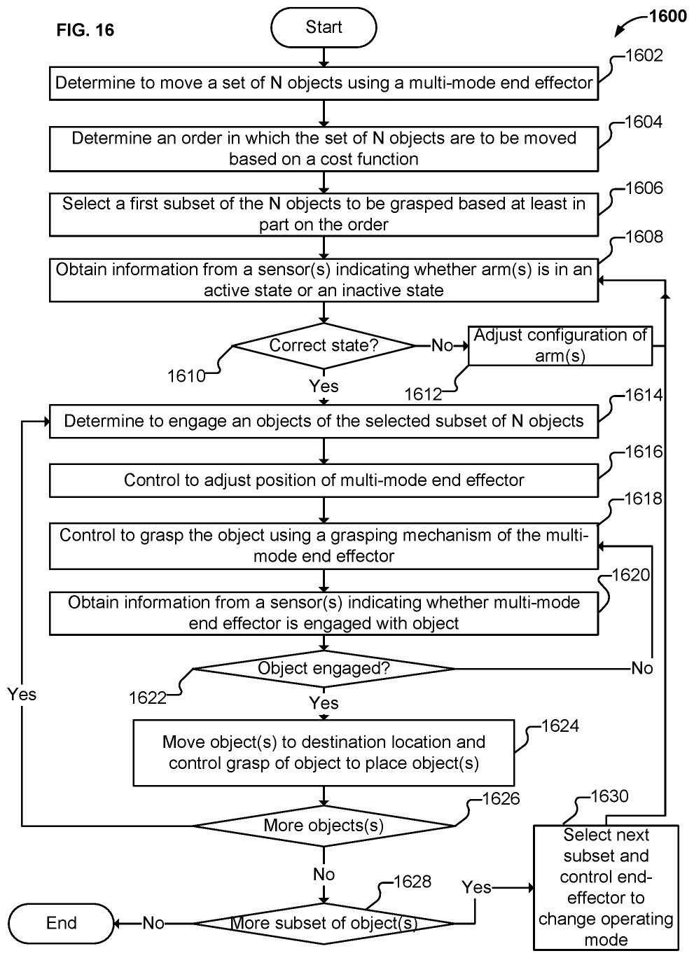

FIG. 16 is a flow diagram of a process for operating an end effector in connection with picking or placing a set of items according to various embodiments. In some embodiments, process 1600 is implemented in connection with controlling end effector 300 of FIGS. 3A-3B. In some embodiments, process 1600 is implemented by system 100 of FIG. 1A, etc. Process 1600 is implemented in connection with grasping a set of items, such as by using different operating modes of a multi-mode end effector.

At 1602, a determination is made to move a set of N objects using a multi-mode end effector. In some embodiments, the system determines a set of N objects to be moved based on a manifest or order corresponding to a kit of items to be assembled/collected for shipment. A subset of the N objects may be items comprised within one or more trays in the workspace of the robotic arm to which the multi-mode end effector is mounted. Another subset of the N objects may be one or more trays in the workspace, such as a top tray in a stack of trays that is empty or that is emptied while the multi-mode end effector is controlled to grasp items from the top tray, or top tray(s) that are to be moved to expose another tray from which items are to be grasped. The system determines the set of N objects based at least in part on information obtained by one or more sensors disposed within the workspace.

At 1604, an order in which the set of N objects are to be moved is determined based at least in part on a cost function. The cost function is based at least in part on one or more of (i) various operating modes in which the various objects are to be grasped, (ii) respective destination locations of the objects, (iii) respective source locations of the objects, (iv) a location(s) of another object(s) or structure in the workspace, (v) an expected trajectory for moving an object, (vi) a cost for transitioning the multi-mode end effector to operate according to different modes, etc.

In some embodiments, the system determines a set of tasks to be performed (e.g., to achieve a higher-level goal such as fulfilling a set of orders) and determines an order in which the set of tasks are to be performed based on a cost function associated with performing the respective tasks within the set of tasks. The system determines the order in which the set of tasks are to be performed based on a cost associated with transitioning to control the multi-mode end effector between the first mode or the second mode. For example, the system determines the order in which the set of tasks are to be performed based at least in part on a cost associated with transitioning the second grasping mechanism (e.g., an end effector comprising a plurality of gripper arms) between the inactive state and the active state.

At 1606, a first subset of the N objects to be grasped is selected based on the order. In some embodiments, the first subset of N objects is selected according to an initial operating mode of the multi-mode end effector. For example, because the order is determined based on a cost function, the cost associated with moving items includes a cost for transitioning the multi-mode end effector between different operating modes/states. As an example, the first subset of N objects is selected to be grasped according to a same operating mode of the multi-mode end effector. For example, the first set of N objects are items to be grasped from a tray using a suction-based end effector to avoid having to change a state of the multi-mode end effector (e.g., transitioning the gripper arms between inactive and active states) during between grasping the various items in the first subset of N objects.

As another example, the first subset of N objects is selected to be grasped according to a same operating state of the multi-mode end effector. For example, the states of gripper arms of the multi-mode end effector are the same for operating in the second mode as operating in the third mode. The second mode can include using the gripper arms to grasp an item, and the third mode can include using a structure/hook on the multi-mode end effector (e.g., on a gripper arm) to push or pull an object such as a cart, stack of trays, etc. Accordingly, a subset of the N objects include an object(s) that is to be moved according to the second mode and an object(s) that is to be moved according to the third mode.

At 1608, information is obtained from one or more sensors. The information indicates whether one or more of the gripper arms is in an active state or an inactive state (or some intermediate state between the inactive state or inactive state). In some embodiments, the system uses the information corresponding to a positioning of the gripper arms in connection with controlling the gripper arms (or second grasping mechanism) to transition to the active state or inactive state according to a mode in which the multi-mode end effector is to be operated.

At 1610, a determination is made as to whether the gripper arms are positioned in a correct state. The correct state corresponds to a state in which the gripper arms are to be positioned while moving the corresponding subset set of N objects. For example, if the subset of items are to be grasped using a suction-based end effector, the correct state for the gripper arms is an inactive state (e.g., a retracted position). As another example, if the subset of objects are to be grasped using the gripper arms, the correct state for the gripper arms is an active state (e.g., a deployed position). In response to determining that the gripper arms are not in the correct state at 1610, process 1600 proceeds to 1612 at which a configuration of the gripper arms is adjusted. For example, the system controls to move (or continue to move) the gripper arms to the corrected state. Process 1600 iterates over 1608-1612 until the system determines that the gripper arms are in the correct state.

In response to determining that the gripper arms are in the correct state at 1610, process 1600 proceeds to 1614 at which the system determines to engage the object, such as an item within a tray or other source location (e.g., shelf, conveyor, etc.) in the case that the selected subset of items are to be moved using the first mode, or a tray in the case that the selected objects are to be moved using the second mode.

At 1616, the system controls to adjust a position of the multi-mode end effector. The system controls to position the multi-mode end effector to engage the object to be grasped. For example, the system moves the robotic arm and end effector to a position at which a suction-cup on the multi-mode end effector engages the object.

At 1618, the system controls the multi-end effector to grasp the object(s) with the multi-mode end effector. The system actuates a grasping mechanism to grasp the object(s). For example, if the multi-mode end effector is to be used to grasp an object using the suction-based end effector, the system actuates a suction mechanism to apply a suction force between one or more suction cups (e.g., comprised in the suction-based end effector) and the objects(s) to be grasped. For example, if the multi-mode end effector is to be used to grasp an object using the end effector having gripper arms, the system actuates a mechanism to change a position of one or more gripper arms to grasp objects(s).

At 1620, information is obtained from one or more sensors. The information indicates whether the suction-based end effector is engaged with the item(s) to be grasped, or whether the gripper arms (e.g., a thumb(s) of the gripper arms) is engaged with the tray to be grasped, etc.

At 1622, the system determines whether the object(s) is engaged. For example, the system determines whether the object(s) are securely grasped by the multi-mode end effector. In response to determining that the objects(s) is not securely grasped (e.g., a suction force between the item and the end effector is less than a threshold suction force, or that the item is not grasped by the gripper arms) at 1622, process 1600 returns to 1618 at which the system controls to grasp the object using the appropriate grasping mechanism. Process 1600 iterates over 1618-1622 until the system determines that the item(s) is securely grasped. In some embodiments, the multi-mode end effector is used to grasp a set of items at once (e.g., for simultaneous movement to respective destination locations), and iteration over 1618-1622 is used to determine whether each of the set of items to be moved are securely grasped.

In response to determining that the object(s) is securely grasped at 1622, process 1600 proceeds to 1624 at which the object(s) is moved to the destination location(s) and the grasp of the object (e.g., by the multi-mode end effector) is controlled to place the object (e.g., to release the object(s) at the destination location(s)).

For example, in the case that the multi-mode end effector is operated in the first mode, the system controls a robotic arm to move the item to the destination location (or proximity of the destination location) and then controls the suction-based end effector to release the item at the destination location. The system controls the suction-based end effector to reduce/eliminate the suction force between the suction-based end effector and the item(s).

For example, in the case that the multi-mode end effector is operated in the second mode, the system controls a robotic arm to move the object to the destination location (or proximity of the destination location) and then controls the second grasping mechanism (e.g., one or more of the gripper arms) to release the object at the destination location.

At 1626, a determination is made as to whether one or more other objects in the applicable subset of objects are to be moved. For example, the system determines whether any additional objects are to be moved while the multi-mode end effector is configured in certain state before transitioning the state of the multi-mode end effector to move another subset of objects.

In response to determining that one or more other objects in the applicable subset of objects are to be moved at 1626, process 1600 returns 1614 and process 1600 iterates over 1614-1626 until the system determines that no further objects are to be moved. Conversely, in response to determining that no further objects in the applicable subset of objects are to be moved at 1626, process 1600 proceeds to 1628.

At 1628, the system determines whether an additional subset(s) of objects are to be moved using the multi-mode end effector. For example, the system determines whether an additional subset(s) objects are to be used using a different mode of the multi-end effector. The other subset of objects are moved using multi-mode end effector in a different configuration/state of the gripper arms than the previous subset of objects.

In response to determining that additional subset(s) of objects are to be moved using the multi-mode end effector at 1628, process 1600 proceeds to 1630 at which a next subset of objects is selected, and the multi-mode end effector is controlled to change an operating mode. For example, the system controls the multi-mode end effector to transition a state of the gripper arms. Process 1600 iterates over 1608-1630 until no further subsets of the set of N objects are to be moved.

Although the foregoing embodiments have been described in connection with the grasping, moving, and placing one or more trays, various other receptacles or containers may be implemented. Examples of other receptacles or containers include bags, boxes, pallets, crates, etc.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic end effector, comprising:
a robotically actuated second gripper;
a robotically actuated first gripper comprising a first element and second element positioned opposite each other on either side of a central vertical axis of the robotic end effector, wherein the robotically actuated second gripper positioned between the first element and the second element; and
a robotically actuated retraction-extension mechanism configured to place the robotic end effector in a first mode of operation in which the first gripper is positioned for use or a second mode of operation in which the second gripper is positioned for use.

2. The robotic end effector of claim 1, wherein:
the robotically actuated second gripper is robotically positioned in an inactive state when the robotic end effector is controlled to operate in the first mode; and
the robotically actuated second gripper is robotically positioned in an active state when the end effector is controlled to operate in the second mode.

3. The robotic end effector of claim 1, wherein the placing the robotic end effector in the first mode exposes at least part of the robotically actuated first gripper for the robotically actuated first gripper to engage a first object.

4. The robotic end effector of claim 1, wherein the robotically actuated second gripper is configured to grasp a tray or other receptacle.

5. The robotic end effector of claim 1, wherein the robotically actuated first gripper is configured to grasp at least one first object is comprised in a tray or other receptacle.

6. The robotic end effector of claim 1, wherein:
the robotic end effector is configured to be connected to a robotic arm; and
the first element and the second element correspond to gripper arms configured to engage two or more sides of an object or a bottom of the object.

7. The robotic end effector of claim 6, wherein placing the robotic end effector in the first mode comprises rotating at least one of the gripper arms to a stowed state, and the rotating the at least one of the gripper arms exposes at least part of the robotically actuated first gripper to engage an object.

8. The robotic end effector of claim 1, wherein the robotically actuated first gripper includes a plurality of suction-based grasping mechanisms and one or more actuation mechanisms to apply suction to the plurality of suction-based grasping mechanisms.

9. The robotic end effector of claim 8, wherein the robotically actuated first gripper is configured to grasp a plurality of first objects at once.

10. The robotic end effector of claim 9, wherein a first subset of grasping mechanisms of the plurality of suction-based grasping mechanisms are configured to be controlled independently from a second subset of grasping mechanisms of the plurality of suction-based grasping mechanisms.

11. The robotic end effector of claim 10, wherein the first subset of grasping mechanisms are controlled to grasp a first subset of one or more first objects, and the second subset of grasping mechanisms are controlled to grasp a second subset of the one or more first objects.

12. The robotic end effector of claim 8, wherein:
the one or more actuation mechanisms is configured to obtain one or more signals from a control computer, and to operate in response to at least one of the one or more signals; and
the one or more actuation mechanisms is determined according to a grasping strategy for grasping one or more first objects in response to at least one of the one or more signals.

13. The robotic end effector of claim 12, wherein at least a subset of the plurality of suction-based grasping mechanisms comprises an extendable suction cup.

14. The robotic end effector of claim 13, wherein the extendable cup is controlled based at least in part on at least one of the one more signals.

15. The robotic end effector of claim 1, further comprising one or more structures configured to engage an object or a cart, and to push or pull the object or the cart.

16. The robotic end effector of claim 15, wherein the one or more structures are disposed on the robotically actuated second gripper.

17. The robotic end effector of claim 1, further comprising:
a lateral member configured to be coupled to a robotic arm,
wherein:
the first element is coupled to the lateral member at a first distal end and configured to engage mechanically with a first recess on a first side of an object to be grasped; and
the second element is coupled to the lateral member at a second distal end opposite the first distal end and configured to engage mechanically with a second recess on a second side of the object to be grasped.

18. The robotic end effector of claim 17, wherein the robotically actuated first gripper is coupled to the lateral member at a location between the first distal end and the second distal end.

19. The robotic end effector of claim 17, further comprising a sensor configured to obtain information pertaining to a position of one or more of the first element or the second element.

20. The robotic end effector of claim 19, wherein the sensor is a mechanical limit switch that is configured to obtain information indicative of whether the one or more of the first element or the second element is in a deployed position corresponding to the second mode and a stowed position corresponding to the first mode.

21. The robotic end effector of claim 19, wherein the sensor is a light sensor that is configured to obtain information indicative of whether the one or more of the first element or the element is in a deployed position corresponding to the second mode and a stowed position corresponding to first mode.

22. The robotic end effector of claim 17, wherein:
one or more of the first element and the second element is movable with respect to the lateral member; and
the one or more of the first element and the second element is configured to move, via robotic control, between a deployed position corresponding to the second mode and a stowed position corresponding to the first mode.

23. An autonomous tray handling robotic system comprising the robotic end effector of claim 1, wherein the system further comprises:
a memory configured to store data indicating a set of output stacks to be assembled, each output stack including an associated set of objects; and
a processor coupled to the memory and configured to control operation of one or more robots, each of the one or more robots being configured to grasp, move, and place one or more first objects at a time, according to a plan, to iteratively pick one or more first objects from source stacks of objects and assemble the set of output stacks, including by building each output stack by successively placing on an output stack a first object or second object picked from one or more corresponding source stacks;
wherein:
each of the robots comprises a robotic arm and the robotic end effector configured to grasp, move, and place the one or more first objects without assistance from another robot.

24. An method, comprising:
determining, by one or more processors, to grasp an object using a robotic arm is configured with a robotic end effector;
determining a strategy for grasping the one or more objects, comprising:
determining to operate the robotic end effector in a first mode of operation or a second mode of operation; and
controlling the robot end effector based at least in part on the strategy, wherein:
the robot end effector comprises a robotically actuated retraction-extension mechanism configured to place the robotic end effector in the first mode or the second mode;
the controlling the robot end effector based at least in part on the strategy includes controlling the robotically actuated retraction-extension mechanism to place the robotic end effector in the first mode or the second mode based at least in part on the strategy.

25. A computer program product embodied in a non-transitory computer readable medium and comprising computer instructions for:
determining, by one or more processors, to grasp an object using a robotic arm configured with a robotic end effector;
determining a strategy for grasping the one or more objects, comprising:
determining to operate the robotic end effector in a first mode of operation or a second mode of operation; and
controlling the robot end effector based at least in part on the strategy,
wherein:
the robot end effector comprises a robotically actuated retraction-extension mechanism configured to place the robotic end effector in the first mode or the second mode;
the controlling the robot end effector based at least in part on the strategy includes controlling the robotically actuated retraction-extension mechanism to place the robotic end effector in the first mode or the second mode based at least in part on the strategy.

26. A system, comprising:
a robot arm configured with a robotic end effector comprising a robotically actuated retraction-extension mechanism configured to place the robotic end effector in a first mode of operation or a second mode of operation; and
a control computer configured to control the robot arm to grasp an object,
wherein:
the control computer is configured to:
determine to grasp an object using a robotic arm configured with a robotic end effector;
determine a strategy for grasping the one or more objects, comprising:
determining to operate the robotic end effector in the first mode or the second mode; and
control the robot end effector based at least in part on the strategy, including controlling the robot end effector based at least in part on the strategy includes controlling the robotically actuated retraction-extension mechanism to place the robotic end effector in the first mode or the second mode based at least in part on the strategy.

27. The system of claim 26, wherein the robotic end effector comprises:
a robotically actuated second gripper;
a robotically actuated first gripper comprising a first element and second element positioned opposite each other on either side of a central vertical axis of the robotic end effector, wherein the robotically actuated second gripper positioned between the first element and the second element; and
a robotically actuated retraction-extension mechanism configured to place the robotic end effector in a first mode of operation in which the first gripper is positioned for use or a second mode of operation in which the second gripper is positioned for use.

28. A robotic end effector, comprising:
a set of suction based grasping mechanisms configured to grasp one or more objects when a suction force is applied;
a robotically controlled actuation mechanism configured to move at least a first subset of suction-based grasping mechanisms to change a relative position of the first subset of suction-based grasping mechanisms and a second subset of suction-based grasping mechanisms.

29. The robotic end effector of claim 28, wherein the set of suction based grasping mechanisms comprise a plurality of suction cups.

30. The robotic end effector of claim 28, wherein changing the relative position of the first subset of suction-based grasping mechanisms and the second subset of suction-based grasping mechanisms changes a distance between at least one of the first subset of suction-based grasping mechanisms and at least one of the second subset of suction-based grasping mechanisms.

31. The robotic end effector of claim 28, wherein the robotically controlled actuation mechanism comprises a pneumatically controlled piston that changes the relative position of the first subset of suction-based grasping mechanisms when actuated.

32. The robotic end effector of claim 28, wherein the robotically controlled actuation mechanism is controlled based on one or more control signals received from a control computer.

33. The robotic end effector of claim 32, wherein the control computer determines to change the relative position of the first subset of suction-based grasping mechanisms and the second subset of suction-based grasping mechanisms based at least in part on a strategy for grasping a particular object.

34. The robotic end effector of claim 33, wherein the control computer determines to increase the distance between at least one of the first subset of suction-based grasping mechanisms and at least one of the second subset of suction-based grasping mechanisms based at least in part on a determination that a size of the particular object exceeds a threshold distance.

35. A multi-mode robotic end effector comprising the robotic end effector of claim 28, wherein the multi-mode robotic end effector is configured to use the robotic end effector of claim 28 in connection with operating the multi-mode robotic end effector in a first mode.
